(19) United States
(12) Patent Application Publication
(10) Pub. No.: US 2022/0245693 A1
(43) Pub. Date: Aug. 4, 2022

(54) ORDER GENERATION METHOD, DATA PROCESSING METHOD, DEVICE, SYSTEM, AND STORAGE MEDIUM

(71) Applicant: Alibaba Group Holding Limited, Grand Cayman (KY)

(72) Inventors: Kai Xu, Hangzhou (CN); Jun Fang, Hangzhou (CN); Jianbing Xiao, Hangzhou (CN); Bo Ge, Hangzhou (CN); Pengfei Ai, Hangzhou (CN)

(21) Appl. No.: 17/721,281

(22) Filed: Apr. 14, 2022

Related U.S. Application Data
(63) Continuation of application No. PCT/CN2020/121792, filed on Oct. 19, 2020.

(30) Foreign Application Priority Data
Oct. 21, 2019 (CN) 201911002732.3

(51) Int. Cl. G06Q 30/06; G06F 3/04842

(52) U.S. Cl. CPC G06Q 30/0621; G06F 3/04842; G06Q 30/0643

(57) ABSTRACT

Embodiments of the present disclosure provide an order generation method, a data processing method, a device, a system, and a storage medium. In some embodiments of the present disclosure, first, a terminal device displays an order page; and then, after a selection operation is performed on at least one to-be-selected fabric, at least one washing effect corresponding to the selected fabric is acquired using a washing prediction model and displayed; and finally, a selection operation is performed on the at least one washing effect; a customized clothing order for the selected fabric is generated according to the selected washing effect. In this way, users may select fabrics via a terminal device, and a washing effect corresponding to a selected fabric may be directly displayed for the users' selection, thus achieving on-line clothing customization and enhancing user experience.

### CROSS REFERENCE TO RELATED APPLICATIONS

This application claims priority to and is a continuation of PCT Patent Application No. PCT/CN2020/121792, filed on 19 Oct. 2020 and entitled “ORDER GENERATION METHOD, DATA PROCESSING METHOD, DEVICE, SYSTEM, AND STORAGE MEDIUM,” which claims priority to Chinese patent application No. 201911002732.3 filed on 21 Oct. 2019 and entitled “ORDER GENERATION METHOD, DATA PROCESSING METHOD, DEVICE, SYSTEM, AND STORAGE MEDIUM,” which are incorporated herein by reference in their entirety.

### TECHNICAL FIELD

The present disclosure relates to the technical field of data processing, and, more particularly, to order generation methods, data processing methods, devices, systems, and storage media.

### BACKGROUND

Clothing customization refers to tailoring clothing to an individual's preferences and situations. The customized clothing is usually produced one piece at a time. Clothing customization is also referred to as personalized fashion design, in which case fabric patterns and clothing styles are usually selected and determined in accordance with an individual's figure, skin tone, occupation, temperament, hobby, etc.

At present, clothing customization is mainly done by customizing a clothing style with few options, thus insufficient in meeting users' customization requirements.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides an order generation method, a data processing method, a device, a system, and a storage medium. Users may select fabrics via a terminal device, and a washing effect corresponding to a selected fabric may be directly displayed for the users' selection, thus achieving on-line clothing customization and enhancing user experience.

The embodiments of the present disclosure provide an order generation method, comprising:

displaying an order page, wherein the order page comprises at least one to-be-selected fabric;

displaying, in response to a selection operation on the at least one to-be-selected fabric, at least one washing effect corresponding to the selected fabric; and

generating, in response to a selection operation on the at least one washing effect, a customized clothing order for the selected fabric, wherein the customized clothing order comprises the selected washing effect.

The embodiments of the present disclosure further provide a data processing method, comprising:

acquiring original attribute information of a to-be-washed fabric;

inputting the original attribute information into a washing prediction model, so as to predict at least one type of target attribute information after the to-be-washed fabric is washed using at least one washing method; and

generating and outputting at least one washing effect according to the at least one type of target attribute information.

The embodiments of the present disclosure further provide a clothing customization system, comprising a terminal device and a server, wherein

the terminal device displays, in response to a selection operation on at least one to-be-selected fabric, at least one washing effect corresponding to the selected fabric sent by the server, and generates, in response to a selection operation on the at least one washing effect, a customized clothing order for the selected fabric, wherein the customized clothing order comprises a selected washing effect; and

the server predicts, according to original attribute information of the selected fabric, at least one type of target attribute information after the selected fabric is washed using at least one washing method, so as to generate the at least one washing effect corresponding to the selected fabric.

The embodiments of the present disclosure further provide a washing system, comprising: a terminal device, a server, and a washing device, wherein

the terminal device displays, in response to a selection operation on at least one to-be-selected fabric, at least one washing effect corresponding to the selected fabric sent by the server, and generates, in response to a selection operation on the at least one washing effect, a customized clothing order for the selected fabric, wherein the customized clothing order comprises a selected washing effect; and

the server predicts, according to original attribute information of the selected fabric, at least one type of target attribute information after the selected fabric is washed using at least one washing method, so as to generate the at least one washing effect corresponding to the selected fabric, and sends washing parameters corresponding to the selected washing effect to the washing device; and

the washing device washes the selected fabric according to the washing parameters corresponding to the selected washing effect issued by the server.

The embodiments of the present disclosure further provide a terminal device, comprising: a memory and a processor, wherein

the memory is configured to store one or more computer-readable instructions; and

the processor is configured to execute the one or more computer-readable instructions for:

displaying an order page, wherein the order page comprises at least one to-be-selected fabric;

displaying, in response to a selection operation on the at least one to-be-selected fabric, at least one washing effect corresponding to the selected fabric; and

generating, in response to a selection operation on the at least one washing effect, a customized clothing order for the selected fabric, wherein the customized clothing order comprises the selected washing effect.

Embodiments of the present disclosure further provide a computer-readable storage medium having a computer program stored thereon, wherein the computer program, when executed by one or more processors, causes the one or more processors to execute the following actions:

displaying an order page, wherein the order page comprises at least one to-be-selected fabric;

displaying, in response to a selection operation on the at least one to-be-selected fabric, at least one washing effect corresponding to the selected fabric; and

generating, in response to a selection operation on the at least one washing effect, a customized clothing order for the selected fabric, wherein the customized clothing order comprises the selected washing effect.

The embodiments of the present disclosure further provide a server, comprising: a memory and a processor, wherein

the memory is configured to store one or more computer-readable instructions; and

the processor is configured to execute the one or more computer-readable instructions for:

acquiring original attribute information of a to-be-washed fabric;

inputting the original attribute information into a washing prediction model, so as to predict at least one type of target attribute information after the to-be-washed fabric is washed using at least one washing method; and

generating and outputting at least one washing effect according to the at least one type of target attribute information.

The embodiments of the present disclosure further provide a computer-readable storage medium having a computer program stored thereon, wherein the computer program, when executed by one or more processors, causes the one or more processors to execute the following actions:

acquiring original attribute information of a to-be-washed fabric;

inputting the original attribute information into a washing prediction model, so as to predict at least one type of target attribute information after the to-be-washed fabric is washed using at least one washing method; and

generating and outputting at least one washing effect according to the at least one type of target attribute information.

The embodiments of the present disclosure further provide an order generation method, comprising:

displaying an order page, wherein the order page comprises at least one clothing style;

displaying, in response to a selection operation on a customization area of the at least one clothing style, at least one to-be-selected fabric;

displaying, in response to a selection operation on the at least one to-be-selected fabric, at least one washing effect corresponding to the selected fabric; and

displaying, in response to a selection operation on the at least one washing effect, a pattern preview of a selected clothing style after it is customized.

The embodiments of the present disclosure further provide an order generation method, comprising:

displaying an order page; and displaying, in response to an import operation for a target pattern on the order page, at least one washing effect meeting a target pattern washing condition; and

generating, in response to a selection operation on the at least one washing effect, a customized clothing order for the selected fabric, wherein the customized clothing order comprises the selected washing effect.

The embodiments of the present disclosure further provide an order generation device, comprising: a memory and a processor, wherein

the memory is configured to store one or more computer-readable instructions; and

the processor is configured to execute the one or more computer-readable instructions for:

displaying an order page, wherein the order page comprises at least one clothing style;

displaying, in response to a selection operation on a customization area of the at least one clothing style, at least one to-be-selected fabric;

displaying, in response to a selection operation on the at least one to-be-selected fabric, at least one washing effect corresponding to the selected fabric; and

displaying, in response to a selection operation on the at least one washing effect, a pattern preview of a selected clothing style after it is customized.

The embodiments of the present disclosure further provide a computer-readable storage medium having a computer program stored thereon, wherein the computer program, when executed by one or more processors, causes the one or more processors to execute the following actions:

displaying an order page, wherein the order page comprises at least one clothing style;

displaying, in response to a selection operation on a customization area of the at least one clothing style, at least one to-be-selected fabric;

displaying, in response to a selection operation on the at least one to-be-selected fabric, at least one washing effect corresponding to the selected fabric; and

displaying, in response to a selection operation on the at least one washing effect, a pattern preview of a selected clothing style after it is customized.

The embodiments of the present disclosure further provide an order generation device, comprising: a memory and a processor, wherein

the memory is configured to store one or more computer-readable instructions; and

the processor is configured to execute the one or more computer-readable instructions for:

displaying an order page; and displaying, in response to an import operation for a target pattern on the order page, at least one washing effect meeting a target pattern washing condition; and

generating, in response to a selection operation on the at least one washing effect, a customized clothing order for the selected fabric, wherein the customized clothing order comprises the selected washing effect.

The embodiments of the present disclosure further provide a computer-readable storage medium having a computer program stored thereon, wherein the computer program, when executed by one or more processors, causes the one or more processors to execute the following actions:

displaying an order page; and displaying, in response to an import operation for a target pattern on the order page, at least one washing effect meeting a target pattern washing condition; and

generating, in response to a selection operation on the at least one washing effect, a customized clothing order for the selected fabric, wherein the customized clothing order comprises the selected washing effect.

In some embodiments of the present disclosure, first, a terminal device displays an order page; and then, after a selection operation is performed on at least one to-be-selected fabric, at least one washing effect corresponding to the selected fabric is acquired and displayed using a washing prediction model; and finally, a selection operation is performed on the at least one washing effect; a customized clothing order for the selected fabric is generated according to the selected washing effect. In this way, users may select fabrics via a terminal device, and a washing effect corresponding to a selected fabric may be directly displayed for the users' selection, thus achieving on-line clothing customization and enhancing user experience.

### BRIEF DESCRIPTION OF DRAWINGS

The accompanying drawings described herein are intended to provide a further understanding of the present disclosure, and constitute a part of the present disclosure. The illustrative embodiments of the present disclosure and the descriptions thereof are used to explain the present disclosure, and do not constitute an improper limitation to the present disclosure. In the drawings:

FIG. 1a is a schematic structural diagram of a clothing customization system according to an exemplary embodiment of the present disclosure;

FIG. 1b is a schematic structural diagram of another clothing customization system according to an exemplary embodiment of the present disclosure;

FIG. 1c is a schematic structural diagram of a washing system according to an exemplary embodiment of the present disclosure;

FIG. 2 is a schematic diagram of an order page according to an exemplary embodiment of the present disclosure;

FIG. 3 is a schematic structural diagram of a training process for a washing prediction model according to an exemplary embodiment of the present disclosure;

FIG. 4 is a schematic flowchart of an order generation method according to an exemplary embodiment of the present disclosure;

FIG. 5 is a schematic flowchart of an order generation method according to an exemplary embodiment of the present disclosure;

FIG. 6 is a schematic flowchart of an order generation method according to an exemplary embodiment of the present disclosure;

FIG. 7 is a schematic flowchart of an order generation method according to an exemplary embodiment of the present disclosure;

FIG. 8 is a schematic structural diagram of a terminal device according to an exemplary embodiment of the present disclosure;

FIG. 9 is a schematic structural diagram of a server according to an exemplary embodiment of the present disclosure;

FIG. 10 is a schematic structural diagram of an order generation device according to an exemplary embodiment of the present disclosure; and

FIG. 11 is a schematic structural diagram of an order generation device according to an exemplary embodiment of the present disclosure.

### DESCRIPTION OF EMBODIMENTS

In order to make the objectives, technical solutions, and advantages of the present disclosure clearer, the technical solutions of the present disclosure will be clearly and completely described below in conjunction with embodiments of the present disclosure and the accompanying drawings. Obviously, the described embodiments are merely some, but not all, of the embodiments of the present disclosure. Based on the embodiments of the present disclosure, all other embodiments obtained by one of ordinary skill in the art without creative efforts should fall within the protection scope of the present disclosure.

At present, there are no on-line clothing customization methods. In order to solve the technical problem, in some embodiments of the present disclosure, first, a terminal device displays an order page; and then, after a selection operation is performed on at least one to-be-selected fabric, at least one washing effect corresponding to the selected fabric is acquired and displayed using a washing prediction model; and finally, a selection operation is performed on the at least one washing effect; a customized clothing order for the selected fabric is generated. In this way, users may select fabrics via a terminal device, and a washing effect corresponding to a selected fabric may be directly displayed for selection for the users, thus achieving on-line clothing customization and enhancing user experience.

The technical solutions provided by the embodiments of the present disclosure will be described in detail below with reference to the accompanying drawings.

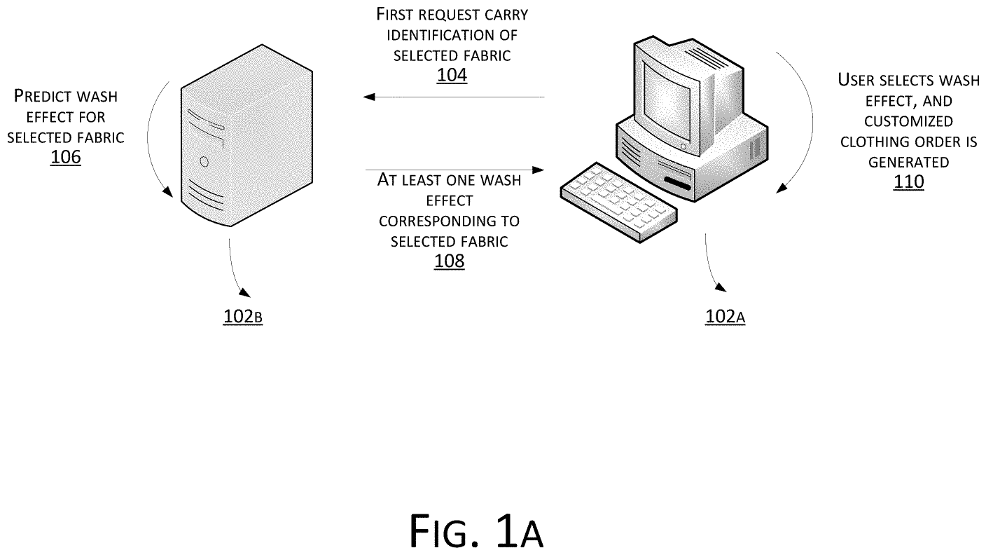

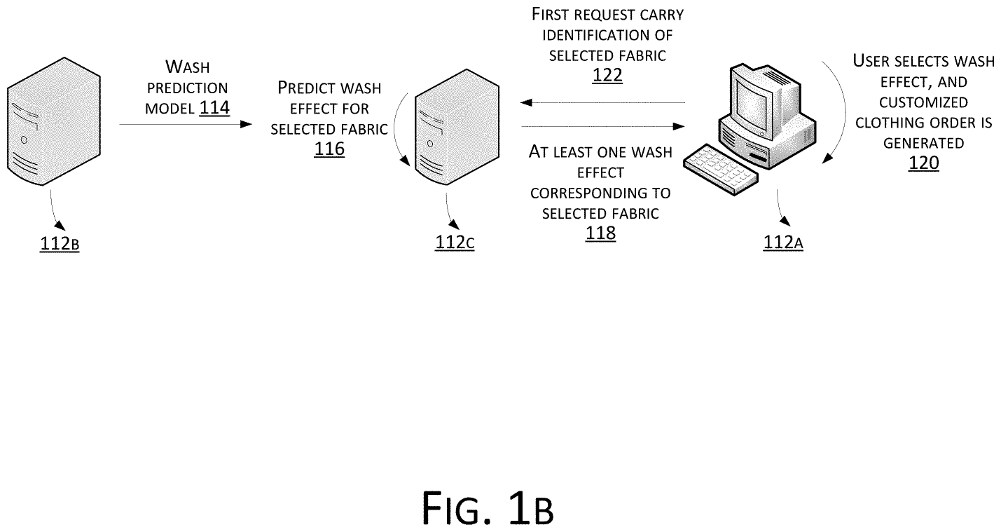

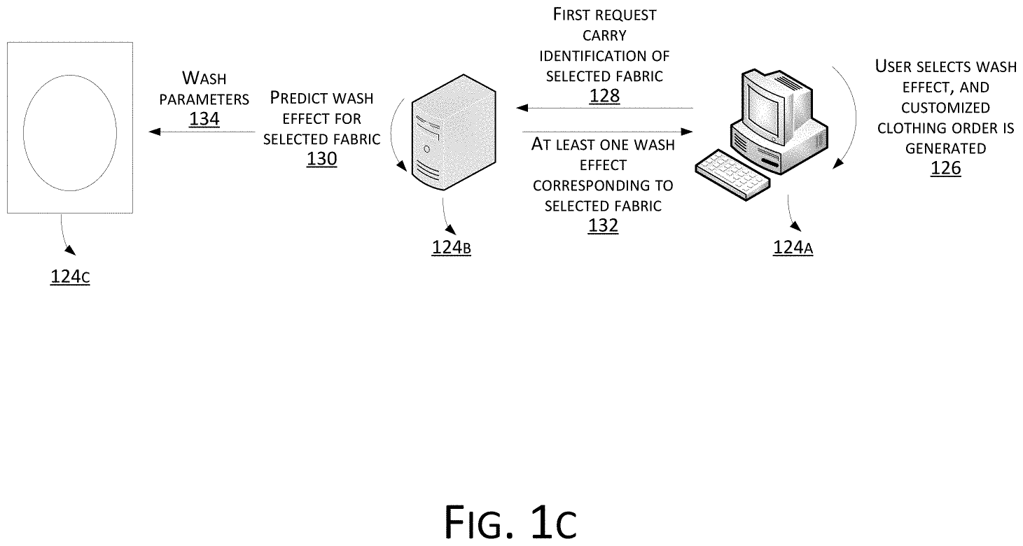

FIG. 1a is a schematic structural diagram of a clothing customization system according to an exemplary embodiment of the present disclosure. As shown in FIG. 1a, the clothing customization system comprises: a terminal device 102a and a server 102b, wherein a communication connection is established between the terminal device 102a and the server 102b; users select fabrics via the terminal device 102a. At 104, a first request carrying identification of selected fabric is sent from the terminal device 102a to the server 102b.

At 106, the server 102b predicts the wash effect for the selected fabric. At 108, the server 102b sends the at least one wash effect corresponding to the selected fabric to the terminal device 102a. At 110, the terminal device 102a receives the user selection of the wash effect, and generates the customized clothing order.

For example, according to original attribute information of the selected fabric, the server 102b uses a washing prediction model to predict at least one type of target attribute information after the selected fabric is washed using at least one washing method, generates at least one washing effect corresponding to the selected fabric based on the at least one type of target attribute information, and finally sends to the washing device 102a the at least one washing effect corresponding to the selected fabric for display. The users will then be able to make a selection operation on the at least one washing effect, and a customized clothing order will be generated for the selected fabric.

In this embodiment, the terminal device 102a refers to a device for users to customize clothing, and the terminal device 102a has functions that the users need, such as calculation, Internet access, and communication. The terminal device 102a may be a computer device or a hand-held device, and may be implemented in various forms such as a smart phone, a personal computer, a wearable device, a tablet computer, etc.

In this embodiment, the server 102b may provide data support, computing services, and some management services for the terminal device 102a. In this embodiment, the implementation form of the server 102b is not limited. For example, the server 102b may be a server device such as a conventional server, a cloud server, a cloud host, a virtual center, etc. Here, the composition of the server device mainly includes a processor, a hard disk, a memory, a system bus, etc., and general computer architectures. The server 102b may include one or more website servers.

In this embodiment, a wireless or wired communication connection is established between the server 102b and the terminal device 102a. For example, the server 102b may establish a communication connection with the terminal device 102a using communication methods, such as Wi-Fi, Bluetooth, and infrared, or the server 102b may also establish a communication connection with the terminal device 102a via a mobile network. Here, the network system of the mobile network may be any one of 2G (GSM), 2.5G (GPRS), 3G (WCDMA, TD-SCDMA, CDMA2000, UTMS), 4G (LTE), 4G+ (LTE+), WiMax, etc.

In this embodiment, the terminal device 102a includes an electronic display screen, through which users may interact with the terminal device 102a. The terminal device 102a may display, on the electronic display screen, a clothing customization interface for users to customize clothing. Users may select a fabric, a predicted washing effect for the selected fabric, etc. on an order page of the clothing customization interface and a customized clothing order is generated.

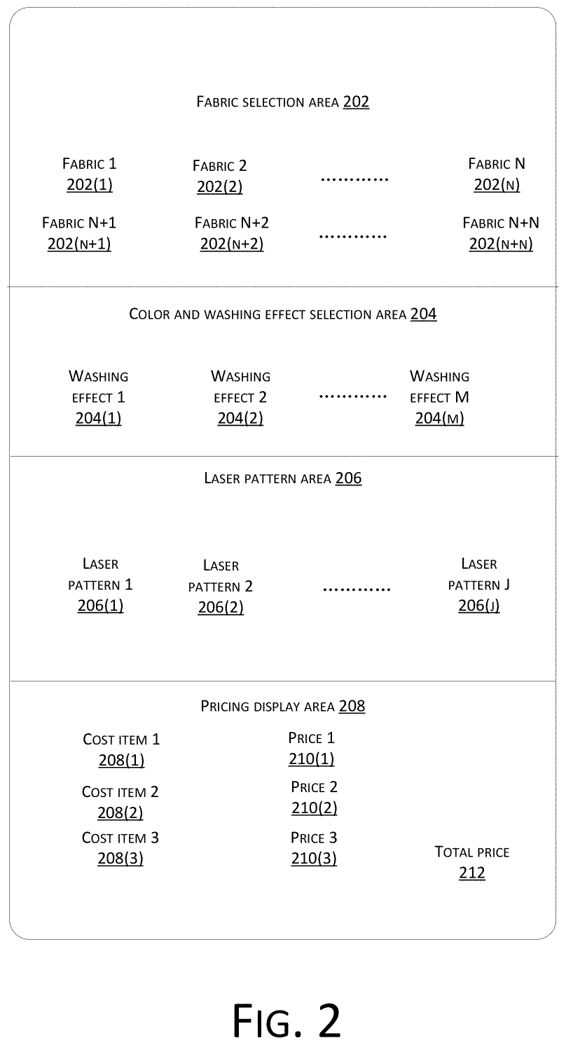

FIG. 2 is a schematic diagram of an order page according to an exemplary embodiment of the present disclosure. The order page may be configured in accordance with users' requirements, which is not limited to the exemplary embodiment of the present disclosure. As shown in FIG. 2, the order page includes four areas vertically arranged from top to bottom: a fabric selection area 202, a color and washing effect selection area 204, a laser pattern area 206, and a pricing display area 208. Areas of the interface may be configured to have some controls, such as text boxes, buttons, and drop-down menus, which may be clicked by users to conveniently perform corresponding operations. In this embodiment, to-be-selected fabric patterns 202(1), 202(2), 202(n), 202(n+1), 202(n+2), . . . , 202(n+n), where n is any integer, are displayed in the fabric selection area, and a selected fabric is confirmed when a selection operation is made on the to-be-selected fabric patterns. At least one color available for selection for the selected fabric is displayed in the color and washing effect selection area 204 when the next control below the fabric selection area is triggered. A selected color is confirmed when a selection operation is made on the at least one color, and at least one washing effect corresponding to the selected fabric with the color selected is displayed for users to view. The washing effects include the washing effect 204(1), 204(2), . . . , 204(m). where m is any integer. A selected washing effect is confirmed when a selection operation is made on the at least one washing effect. At least one color available for selection may be re-displayed for re-selection in the color and washing effect selection area 204 when a triggering operation is made on the previous control below the color and washing effect selection area. The process is turned to the selection operation on laser patterns when a triggering operation is made on the next control below the color and washing effect selection area. In addition, at least one laser pattern is further displayed in the laser pattern area on the order page. The laser patterns include the laser pattern 206(1), 206(2), . . . , 206(j), where j may be any integer.

A selected laser pattern is confirmed when a selection operation is made on at least one laser pattern. According to the selected washing effect and the selected laser pattern, a customized clothing order is generated for the selected fabric, and a washing process and a price of the customized clothing are displayed in the pricing display area 208. For example, the cost item 1 208(1) and the corresponding price 1 210(1), the cost item 2 208(2) and the corresponding price 2 210(2), the cost item 3 208(3) and the corresponding price 3 210(3), and the total price 212 are displayed at the pricing display area 208.

At least one washing effect available for selection may be re-displayed for re-selection in the color and washing effect selection area when a triggering operation is made on the previous control below the laser pattern area. The process turns to the order confirmation operation when the next control below the laser pattern area is triggered. Laser patterns for selection may be re-displayed for re-selection in the laser pattern area when a triggering operation is made on the previous control below the pricing display area. A customized clothing order is placed when a triggering operation is made on the next control below the laser pattern area and a triggering operation is made on the confirmation control below the pricing display area. The order page in this embodiment of the present disclosure is not limited to the order page illustrated above, and the specific formats of the order page in this embodiment may be adjusted according to actual needs. The present disclosure does not limit the process of placing the customized clothing order, either. The process of placing the customized clothing order will be further described through various embodiments below.

In the embodiments described above and below, the triggering operation and the selection operation respectively include, but are not limited to, at least one of the following: a click, a double-click, a mouse hover, and a long press.

In this embodiment, the order page is displayed on the electronic display screen of the terminal device 102a, and includes at least one to-be-selected fabric. In response to a selection operation on the at least one to-be-selected fabric, the terminal device 102a displays at least one washing effect corresponding to the selected fabric; and in response to a selection operation on the at least one to-be-selected washing effect, the terminal device 102a generates a customized clothing order for the selected fabric. It should be noted that the present disclosure does not limit the types of customized clothing, examples of which may be jeans, suits, and shirts.

In this embodiment, in response to the selection operation on the at least one to-be-selected fabric, the terminal device 102a displays at least one washing effect corresponding to the selected fabric. Implementation manners include, but are not limited to, the following.

Implementation manner I: the terminal device 102a sends, in response to a selection operation on the at least one to-be-selected fabric, to the server a first request carrying an identification of the selected fabric; the server 102b receives the first request sent by the terminal device, and selects from a database at least one washing effect corresponding to the selected fabric according to the identification of the selected fabric, and finally returns the at least one washing effect to the terminal device, for the terminal device to display the at least one washing effect.

Implementation manner II: the terminal device 102a sends, in response to a selection operation on the at least one to-be-selected fabric, to the server 102b a second request carrying an identification of the selected fabric; and the server 102b receives the second request sent by the terminal device 102a, acquires from a database original attribute information of the selected fabric according to the identification of the selected fabric, inputs the original attribute information into a washing prediction model, so as to predict at least one washing effect after the selected fabric is washed using at least one washing method, and finally returns the at least one washing effect to the terminal device, for the terminal device 102a to display the at least one washing effect.

In the above-described implementation manner I, at least one washing effect corresponding to all to-be-selected fabrics is acquired in advance by using the washing prediction model, and the at least one washing effect is stored into a database of the server 102b. In response to the selection operation on at least one to-be-selected fabric, the terminal device 102a sends to the server a request carrying an identification of the selected fabric. According to the identification of the selected fabric, the server 102b selects from the database at least one washing effect corresponding to the selected fabric.

In the above-described implementation manner II, original attribute information of all to-be-selected fabrics is stored in advance in the database of the server 102b. In response to the selection operation on at least one to-be-selected fabric, the terminal device 102a sends to the server 102b a request carrying the identification of the selected fabric. According to the identification of the selected fabric, the server 102b acquires from the database original attribute information of the selected fabric and inputs the original attribute information into the washing prediction model, so as to predict at least one washing effect after the selected fabric is washed using at least one washing method. In this implementation manner, based on the request carrying the identification of the selected fabric sent by the terminal device 102a, the server 102b uses the washing prediction model to predict in real time at least one washing effect after the selected fabric is washed, and displays in real time the at least one washing effect.

In the above-described embodiment, it can be seen that advance training is required to obtain the washing prediction model, such that at least one washing effect corresponding to the selected fabric may be acquired based on the trained washing prediction model. The server 102b thus needs to first collect sample data for training and the washing prediction model is then obtained. Before the model is trained, it is necessary to collect attribute information of a sample fabric before washing, washing parameters used for the sample fabric, and attribute information of the sample fabric after washing as a sample data set, which is annotated to form an annotated data set for training the model.

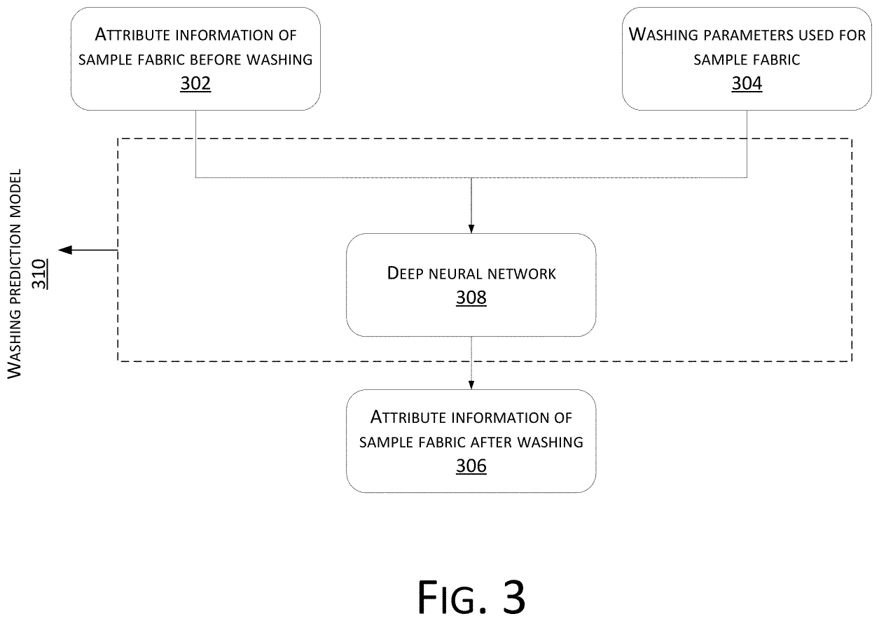

FIG. 3 is a schematic structural diagram of a training process for a washing prediction model according to an exemplary embodiment of the present disclosure. As shown in FIG. 3, the network structure of the washing prediction model according to the embodiment of the present disclosure is constructed using the deep neural network. Attribute information of a sample fabric before washing 302, washing parameters used for the sample fabric 304, and attribute information of the sample fabric after washing 306 are inputted into a deep neural network algorithm 308 to train the washing prediction model 310. A mapping relationship among the attribute information of the sample fabric before washing 302, the washing parameters used for the sample fabric 304, and the attribute information of the sample fabric after washing 306 is established, and the washing prediction model 310 is obtained.

In the above-described embodiment, original attribute information of the sample fabric before washing includes at least one of the following: warp and weft tear strength, tear resistance, wear resistance, air permeability, K/S value, compressive stiffness, crease recovery angle, fabric composition, warp and weft yarn specifications, warp and weft density, color value, and fabric weight; and target attribute information of the sample fabric after washing includes at least one of the following: warp and weft tear strength, tear resistance, wear resistance, air permeability, K/S value, compressive stiffness, crease recovery angle, fabric composition, warp and weft yarn specifications, warp and weft density, and color value.

In this embodiment, a training device for the washing prediction model may be the server 102b or may be a separate server. When the training device for the washing prediction model is a separate server, the separate server needs to send to the server 102b a trained parameter prediction model for the server 102b to acquire at least one washing effect corresponding to a to-be-washed fabric.

In this embodiment, after the server 102b has acquired the trained parameter prediction model, the server 102b uses the parameter prediction model to acquire at least one washing effect corresponding to a to-be-selected fabric. An optional implementation is as follows: first, original attribute information of a to-be-selected fabric is acquired; the original attribute information is inputted into the washing prediction model to predict at least one type of target attribute information after the to-be-selected fabric is washed using at least one washing method; and according to the at least one type of target attribute information, at least one washing effect is generated and outputted. In this embodiment, the at least one washing effect is displayed on the electronic display screen of the terminal device 102a. The format for the at least one washing effect outputted from the server may further include, but is not limited to, the following manners: returning the at least one washing effect to a data requester using manners such as emails, application messages, and short messages; the at least one washing effect is delivered using voice, and the at least one washing effect is delivered via printing with a printer.

In the above-described embodiment, the manner in which the original attribute information of the to-be-selected fabric is acquired includes, but is not limited to, the following.

Acquisition manner I: the server 102b receives a fabric attribute acquisition request sent by the terminal device 102a, wherein the fabric attribute acquisition request carries an identification of the selected fabric; according to the identification of the selected fabric, original attribute information of the selected fabric is acquired from a database as the original attribute information of the to-be-selected fabric.

Acquisition manner II: the server 102b receives the original attribute information of the to-be-selected fabric tested and reported by a testing device before the to-be-selected fabric is washed.

Acquisition manner III: the server 102b receives a fabric attribute acquisition request sent by the terminal device 102a, wherein the fabric attribute acquisition request carries an identification of the selected fabric; according to the identification of the selected fabric, some original attribute information of the selected fabric are acquired from a database; the server 102b receives the remaining original attribute information of the selected fabric tested and reported by a testing device before the selected fabric is washed as the original attribute information of the to-be-selected fabric.

In the above-described acquisition manner I, the server 102b pre-stores the original attribute information of the to-be-selected fabric; the server 102b receives the fabric attribute acquisition request sent by the terminal device, and identifies the identification of the selected fabric from the fabric attribute acquisition request; according to the identification of the selected fabric, original attribute information of the selected fabric is acquired from the database as the original attribute information of the to-be-selected fabric.

In the above-described acquisition manner II, the original attribute information of the to-be-selected fabric may further be acquired by testing the physical to-be-selected fabric with various testing devices, for example, by testing the color value of the to-be-selected fabric with a colorimeter, by testing the fabric weight of the to-be-selected fabric with a weight sensor, etc.

In the above-described acquisition manner III, the server 102b acquires some original attribute information of the to-be-selected fabric using the above-described acquisition manner I, and the server 102b acquires the remaining original attribute information of the to-be-selected fabric using the above-described acquisition manner II.

It should be noted that in this embodiment, the at least one washing effect is a predicted effect after the selected fabric is washed using at least one washing method. Different washing effects may be acquired when the to-be-selected fabric is washed using different washing methods. Here, a washing method includes at least one washing process performed in sequence, and the parameters of the washing process in different washing methods are not exactly the same. For example, different washing methods for the to-be-selected fabric, namely washing method M1, washing method M2, and washing method M3, can produce different washing effects, namely washing effect E1, washing effect E2, and washing effect E3. The washing method M1 includes a washing process A and a washing process B, wherein the washing process A includes a parameter a1 and a parameter a2, and the washing process B comprises a parameter b1 and a parameter b2. When the to-be-selected fabric is washed using the washing method M1, the washing parameters included therein are the parameter a1 and the parameter b2.

In the above-described embodiment, in response to a selection operation on at least one to-be-selected fabric, at least one washing effect corresponding to the selected fabric is displayed, one achievable manner of which is as follows: in response to the selection operation on the at least one to-be-selected fabric, display at least one type of color information that can be used for the selected fabric; and in response to a selection operation on the at least one type of color information, display the at least one washing effect corresponding to the selected fabric according to the selected color information. After a color is selected, at least one washing effect corresponding to the color of the selected fabric is displayed.

In the above-described embodiment, when a piece of denim clothing is to be customized, at least one laser pattern may be further displayed on the order page. In response to a selection operation on the at least one washing effect, a customized clothing order for the selected fabric is generated, wherein the customized clothing order includes the selected washing effect. An achievable manner is as follows: in response to the selection operation on the at least one washing effect, determine the selected washing effect; and in response to a selection operation on the at least one laser pattern, generate the customized clothing order for the selected fabric according to the selected washing effect and the selected laser pattern. In this embodiment, in the customization process of a pair of jeans, at least one laser pattern may be displayed after the washing effect is selected, wherein the laser pattern may also be displayed on the order page the whole time, so as to achieve the customization of the jeans having the laser pattern, which is whiskers or monkey on the denim clothing.

In this embodiment, in the customization process, the terminal device 102a may further display at least one washing process and a price thereof included in a target washing method that produces the selected washing effect. An optional implementation manner is as follows: in response to the selection operation on the at least one washing effect, display at least one washing process and a price thereof included in a target washing method that produces the selected washing effect. Further, in response to the selection operation on the at least one washing effect, a third request carrying an identification of the target washing method is sent to the server 102b. The server 102b receives the third request, and acquires the at least one washing process and the price thereof included in the target washing method according to the identification of the target washing method, and returns the at least one washing process and the price thereof included in the target washing method to the terminal device 102a. The terminal device 102a receives the at least one washing process and the price thereof included in the target washing method returned by the server and displays the same.

After a user confirms a washing effect and a laser pattern, the terminal device 102a may display a customization price corresponding to the selected fabric on the order page to be viewed by the user. An optional implementation manner is as follows: in response to the selection operation on the at least one laser pattern, acquire and display the customization price corresponding to the selected fabric according to the selected washing effect and the selected laser pattern. Further, after the customization price corresponding to the selected fabric is acquired and displayed in accordance with the selected washing effect and the selected laser pattern, a fourth request carrying an identification of the selected laser pattern is sent to the server. The server 102b, in accordance with the selected washing effect and the selected laser pattern, calculates and returns the customization price corresponding to the selected fabric, and sends the customization price for the selected fabric to the terminal device 102a. The terminal device 102a receives the customization price for the selected fabric returned by the server 102b and displays the same.

In the embodiments described above and below, the first request, second request, third request, and fourth request are not limited in the present disclosure and can be adjusted according to actual needs.

FIG. 1b is a schematic structural diagram of another clothing customization system according to an exemplary embodiment of the present disclosure. As shown in FIG. 1b, the washing system includes a terminal device 112a, a first server 112b, and a second server 112c. The first server 112b is a device that provides training services for a washing prediction model at 114, and the second server 112c is a device that predicts at least one washing effect corresponding to a to-be-selected fabric at 116. The first server 112b sends to the second server 112c a trained washing prediction model. The second server 112c generates, according to original attribute information of the to-be-selected fabric, at least one washing effect corresponding to the to-be-selected fabric at 118 and outputs the same to the terminal device 112a for display, for users to complete customized clothing orders via the terminal device 112a at 120. The terminal device 112a sends the first request carrying identification of the selected fabric at 122. In this embodiment, reference may be made to the foregoing embodiments for the method used by the second server 112c to predict the at least one washing effect for the to-be-selected fabric and the manner in which the users complete the customized clothing orders via the terminal device 112a. Details will not be elaborated again in this embodiment.

The server 102b may be excluded in another system architecture in which the washing prediction model may be integrated into the terminal device 102a, and the terminal device 102a uses the washing prediction model to predict at least one washing effect corresponding to the selected fabric and displays the same.

FIG. 1c is a schematic structural diagram of a washing system according to an exemplary embodiment of the present disclosure. As shown in FIG. 1c, the washing system includes a terminal device 124a, a server 124b, and a washing device 124c.

In this embodiment, reference may be made to the foregoing embodiments for the process in which a user generates a customized clothing order via the terminal device 124a and the server 124b. At 126, the user selects the wash effects, and the customized clothing order is generated via the terminal device 126. At 128, the terminal device 124a sends the first request carrying the identification of the selected fabric to the server 124b. At 130, the server 124b predicts the wash effect for the selected fabric. At 132, the server 124b sends at least one wash effect corresponding to the selected fabric to the terminal device 124a. Details will not be elaborated again in this embodiment. After the user generates the customized clothing order via the terminal device 124a, at 134, the server 124b sends to the washing device 124c the washing parameters of a washing method corresponding to a target washing effect, such that a washing operation may be performed.

In the clothing customization system embodiments and the washing system embodiments of the present disclosure, first, a terminal device displays an order page; and then, after a selection operation is first, a terminal device displays an order page; and then, after a selection operation is performed on at least one to-be-selected fabric, at least one washing effect corresponding to the selected fabric is acquired and displayed using a washing prediction model; and finally, a selection operation is performed on the at least one washing effect, and a customized clothing order for the selected fabric is generated. In this way, users may select fabrics via the terminal device, and a washing effect corresponding to a selected fabric may be directly displayed for the users' selection, thus achieving on-line clothing customization and enhancing user experience.

In addition to the clothing customization system and the washing system described above, some embodiments of the present disclosure further provide an order generation method, which may be applied to the clothing customization system and the washing system described above, but is not limited to the clothing customization system and the washing system provided by the above embodiments.

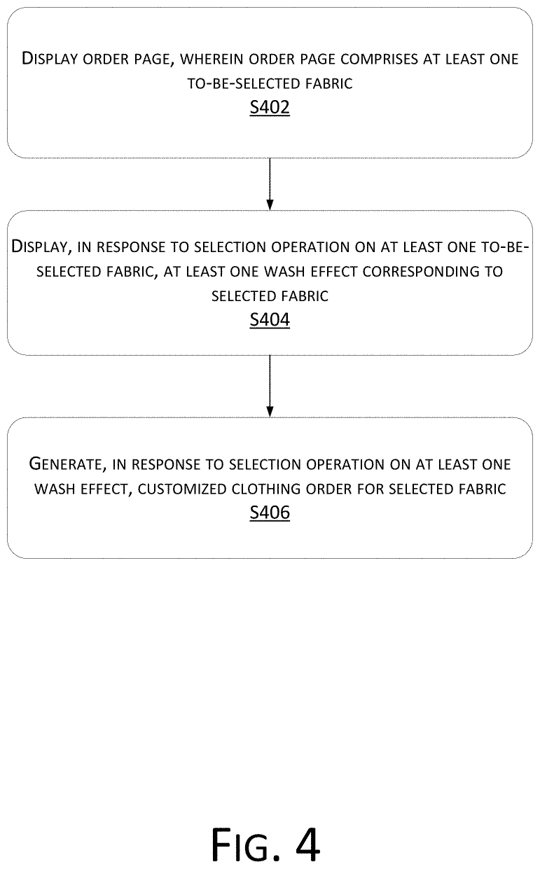

FIG. 4 is a schematic flowchart of an order generation method according to an exemplary embodiment of the present disclosure. As shown in FIG. 4, the method includes the following steps:

S402: display an order page, wherein the order page comprises at least one to-be-selected fabric;

S404: display, in response to a selection operation on the at least one to-be-selected fabric, at least one washing effect corresponding to the selected fabric; and

S406: generate, in response to a selection operation on the at least one washing effect, a customized clothing order for the selected fabric, wherein the customized clothing order includes the selected washing effect.

It may be a computer device or a hand-held device, and may be implemented in various forms, such as a smart phone, a personal computer, a wearable device, a tablet computer, etc. FIG. 2 is a schematic diagram of an order page according to an exemplary embodiment of the present disclosure. The order page may be configured in accordance with users' requirements, which is not limited to the exemplary embodiment of the present disclosure. As shown in FIG. 2, the order page includes four areas vertically arranged from top to bottom: a fabric selection area, a color and washing effect selection area, a laser pattern area, and a pricing display area. Areas of the interface may be configured to have some controls, such as text boxes, buttons, and drop-down menus, which may be clicked by users to conveniently perform corresponding operations. In this embodiment, to-be-selected fabric patterns are displayed in the fabric selection area, and a selected fabric is confirmed when a selection operation is made on the to-be-selected fabric patterns. At least one color available for selection for the selected fabric is displayed in the color and washing effect selection area when the next control below the fabric selection area is triggered. A selected color is confirmed when a selection operation is made on the at least one color, and at least one washing effect corresponding to the selected fabric with the color selected is displayed for users to view. A selected washing effect is confirmed when a selection operation is made on the at least one washing effect. At least one color available for selection may be re-displayed for re-selection in the color and washing effect selection area when a triggering operation is made on the previous control below the color and washing effect selection area. The process is turned to the selection operation on laser patterns when a triggering operation is made on the next control below the color and washing effect selection area. In addition, at least one laser pattern is further displayed in the laser pattern area on the order page. A selected laser pattern is confirmed when a selection operation is made on at least one laser pattern. According to the selected washing effect and the selected laser pattern, a customized clothing order is generated for the selected fabric, and a washing process and a price of the customized clothing are displayed in the pricing display area. At least one washing effect available for selection may be re-displayed for re-selection in the color and washing effect selection area when a triggering operation is made on the previous control below the laser pattern area. The process turns to the order confirmation operation when the next control below the laser pattern area is triggered. Laser patterns available for selection may be re-displayed for re-selection in the laser pattern area when a triggering operation is made on the previous control below the pricing display area. A customized clothing order is placed when a triggering operation is made on the next control below the laser pattern area and a triggering operation is made on the confirmation control below the pricing display area. The order page in this embodiment of the present disclosure is not limited to the order page illustrated above, and the specific formats of the order page in this embodiment may be adjusted according to actual needs. The present disclosure does not limit the process of placing the customized clothing order, either. The process of placing the customized clothing order will be further described through various embodiments below.

In the embodiments described above and below, the triggering operation and the selection operation respectively include, but are not limited to, at least one of the following: a click, a double-click, a mouse hover, and a long press.

In this embodiment, the order page is displayed on an electronic display screen of a terminal device, and includes at least one to-be-selected fabric. In response to a selection operation on the at least one to-be-selected fabric, at least one washing effect corresponding to the selected fabric is displayed; and in response to a selection operation on the at least one to-be-selected washing effect, a customized clothing order for the selected fabric is generated. It should be noted that the present disclosure does not limit the types of customized clothing, examples of which may be jeans, suits, and shirts.

In this embodiment, in response to a selection operation on the at least one to-be-selected fabric, at least one washing effect corresponding to the selected fabric is displayed. An achievable manner is as follows: in response to the selection operation on the at least one to-be-selected fabric, determine at least one washing process to be used for the selected fabric, and display parameters of the at least one washing process; and in response to a combination operation on the parameters of the at least one washing process, obtain at least one washing parameter combination, and display washing effects corresponding to each of the at least one washing parameter combination.

In the above-described embodiment, in response to the selection operation on the at least one washing effect, the customized clothing order for the selected fabric is generated. An achievable manner is as follows: in response to a selection operation on the washing effects corresponding to each of the at least one washing parameter combination, generate the customized clothing order for the selected fabric, wherein the customized clothing order includes the selected washing effect and a washing parameter combination corresponding to the selected washing effect.

In the above-described embodiment, before a response is made to the selection operation on the at least one washing effect, it is required to determine, among the at least one washing effect, whether a washing effect that meets requirements of the customized clothing order is present. If a washing effect meeting the requirements of the order is not present, at least one new washing parameter combination is obtained in response to a recombination operation on the parameters of the at least one washing process, and new washing effects corresponding to each of the at least one new washing parameter combination are displayed.

In this embodiment, after the customized clothing order for the selected fabric is generated, the selected washing effect is sent to a server, for the server to determine, in accordance with the selected washing effect, a target washing parameter required for a washing device to perform washing on the selected fabric.

In the above-described embodiment, the order page further includes a clothing pattern, and a user may customize a piece of clothing by selecting a local area of the clothing pattern. An optional embodiment is as follows: in response to a selection operation on the local area of the clothing pattern, display at least one to-be-selected fabric; and in response to a preview operation on a piece of customized clothing, display a new clothing style pattern with the local area having been covered with the selected washing effect. Thus, a more user-intuitive experience is provided.

It should be noted that the user group targeted by a clothing customization platform corresponding to the order generation method in the above-described embodiments of the present disclosure may be general users having the order needs, or the user group may be designers who may use the above-described clothing customization platform to design clothing styles and provide the finished design proposals onto other platforms.

In this embodiment, in response to a selection operation on at least one to-be-selected fabric, at least one washing effect corresponding to the selected fabric is displayed. Implementation manners include, but are not limited to, the following.

Implementation manner I: in response to a selection operation on the at least one to-be-selected fabric, a first request carrying an identification of the selected fabric is sent to a server; the server receives the first request sent by the terminal device, and selects from a database at least one washing effect corresponding to the selected fabric according to the identification of the selected fabric, and returns the at least one washing effect to the terminal device, for the terminal device to display the at least one washing effect.

Implementation manner II: in response to a selection operation on the at least one to-be-selected fabric, a second request carrying an identification of the selected fabric is sent to the server; the server receives the second request sent by the terminal device, acquires from a database original attribute information of the selected fabric according to the identification of the selected fabric, inputs the original attribute information into a washing prediction model, so as to predict at least one washing effect after the selected fabric is washed using at least one washing method, and returns the at least one washing effect to the terminal device, for the terminal device to display the at least one washing effect.

It should be noted that in this embodiment, the at least one washing effect is a predicted effect after the selected fabric is washed using at least one washing method. Different washing effects may be acquired when the to-be-selected fabric is washed using different washing methods. Here, a washing method includes at least one washing process performed in sequence, and the parameters of the washing process in different washing methods are not exactly the same. For example, different washing methods for the to-be-selected fabric, namely washing method M1, washing method M2, and washing method M3, can produce different washing effects, namely washing effect E1, washing effect E2, and washing effect E3. The washing method M1 includes a washing process A and a washing process B, wherein the washing process A includes a parameter a1 and a parameter a2, and the washing process B comprises a parameter b1 and a parameter b2. When the to-be-selected fabric is washed using the washing method M1, the washing parameters included therein are the parameter a1 and the parameter b2.

In the above-described embodiment, in response to a selection operation on at least one to-be-selected fabric, at least one washing effect corresponding to the selected fabric is displayed, one achievable manner of which is as follows: in response to the selection operation on the at least one to-be-selected fabric, display at least one type of color information that can be used for the selected fabric; and in response to a selection operation on the at least one type of color information, display the at least one washing effect corresponding to the selected fabric according to the selected color information. After a color is selected, at least one washing effect corresponding to the color of the selected fabric is displayed.

In the above-described embodiment, when a piece of denim clothing is to be customized, at least one laser pattern may be further displayed on the order page. In response to a selection operation on the at least one washing effect, a customized clothing order for the selected fabric is generated. An achievable manner is as follows: in response to the selection operation on the at least one washing effect, determine the selected washing effect; and in response to a selection operation on the at least one laser pattern, generate the customized clothing order for the selected fabric according to the selected washing effect and the selected laser pattern. In this embodiment, in the customization process of a pair of jeans, at least one laser pattern may be displayed after the washing effect is selected, wherein the laser pattern may also be displayed on the order page the whole time, so as to achieve the customization of the jeans having the laser pattern, which is whisker or monkey on the denim clothing.

In this embodiment, in the customization process, the terminal device may further display at least one washing process and a price thereof included in a target washing method that produces the selected washing effect. An optional implementation manner is as follows: in response to the selection operation on the at least one washing effect, display at least one washing process and a price thereof included in a target washing method that produces the selected washing effect. Further, in response to the selection operation on the at least one washing effect, a third request carrying an identification of the target washing method is sent to the server. The server receives the third request and acquires the at least one washing process and the price thereof included in the target washing method according to the identification of the target washing method, and returns the at least one washing process and the price thereof included in the target washing method to the terminal device. The terminal device receives the at least one washing process and the price thereof included in the target washing method returned by the server and displays the same.

After a user confirms a washing effect and a laser pattern, a customization price corresponding to the selected fabric may be displayed on the order page to be viewed by the user. An optional implementation manner is as follows: in response to the selection operation on the at least one laser pattern, acquire and display the customization price corresponding to the selected fabric according to the selected washing effect and the selected laser pattern. Further, after the customization price corresponding to the selected fabric is acquired and displayed in accordance with the selected washing effect and the selected laser pattern, a fourth request carrying an identification of the selected laser pattern is sent to the server. The server, in accordance with the selected washing effect and the selected laser pattern, calculates and returns the customization price corresponding to the selected fabric, and sends the customization price for the selected fabric to the terminal device. The terminal device receives the customization price for the selected fabric returned by the server and displays the same.

In the embodiments described above and below, the first request, second request, third request, and fourth request are not limited in the present disclosure and can be adjusted according to actual needs.

In the order generation method embodiments of the present disclosure, first, a terminal device displays an order page; and then, after a selection operation is performed on at least one to-be-selected fabric, at least one washing effect corresponding to the selected fabric is acquired and displayed using a washing prediction model; and finally, a selection operation is performed on the at least one washing effect, and a customized clothing order for the selected fabric is generated. In this way, users may select fabrics via the terminal device, and a washing effect corresponding to a selected fabric may be directly displayed for the users' selection, thus achieving on-line clothing customization and enhancing user experience.

In addition to the clothing customization system and the washing system described above, some embodiments of the present disclosure further provide a data processing method, which may be applied to the clothing customization system and the washing system described above, but is not limited to the clothing customization system and the washing system provided by the above embodiments.

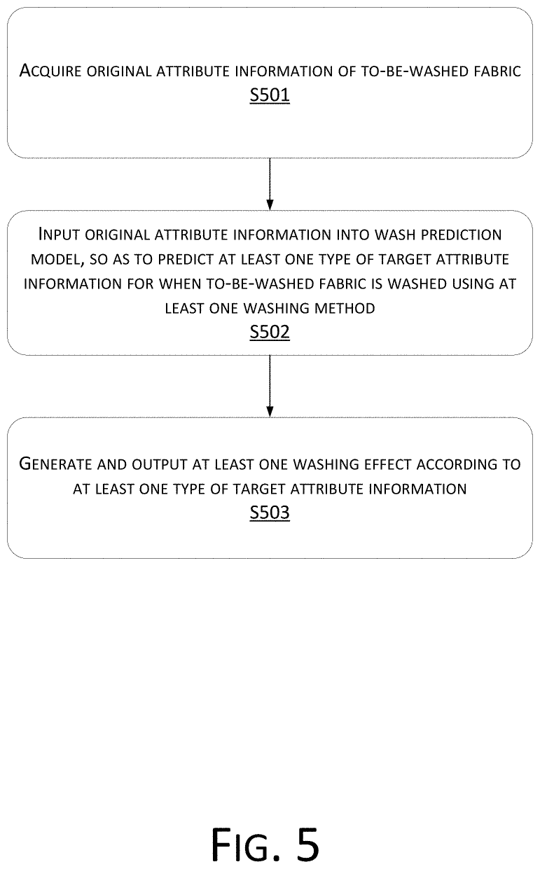

FIG. 5 is a schematic flowchart of an order generation method according to an exemplary embodiment of the present disclosure. As shown in FIG. 5, the method includes the following steps:

S502: acquire original attribute information of a to-be-washed fabric;

S504: input the original attribute information into a washing prediction model, so as to predict at least one type of target attribute information after the to-be-washed fabric is washed using at least one washing method; and

S506: generate and output at least one washing effect according to the at least one type of target attribute information.

In this embodiment of the present disclosure, the executing body of the present disclosure may be multiple servers having data support, computing services, and some management services. However, the implementation format of the server is not limited. For example, the server may be a server device such as a conventional server, a cloud server, a cloud host, a virtual center, etc. Here, the composition of the server device mainly includes a processor, a hard disk, a memory, a system bus, etc., and general computer architectures. The server may include one or more website servers.

In this embodiment, advance training is required to obtain the washing prediction model, such that at least one washing effect corresponding to the to-be-washed fabric may be acquired based on the trained washing prediction model. Therefore, it is required to first collect sample data for training, and the washing prediction model is then obtained. Before the model is trained, it is necessary to collect attribute information of a sample fabric before washing, washing parameters used for the sample fabric, and attribute information of the sample fabric after washing as a sample data set, which is annotated to form an annotated data set for training the model.

FIG. 3 is a schematic structural diagram of a training process for a washing prediction model according to an exemplary embodiment of the present disclosure. As shown in FIG. 3, the network structure of the washing prediction model according to the embodiment of the present disclosure is constructed using the deep neural network. Attribute information of a sample fabric before washing, washing parameters used for the sample fabric, and attribute information of the sample fabric after washing are inputted into a deep neural network algorithm to train the model; a mapping relationship among the attribute information of the sample fabric before washing, the washing parameters used for the sample fabric, and the attribute information of the sample fabric after washing is established, and the washing prediction model is obtained.

In the above-described embodiment, original attribute information of the sample fabric before washing includes at least one of the following: warp and weft tear strength, tear resistance, wear resistance, air permeability, K/S value, compressive stiffness, crease recovery angle, fabric composition, warp and weft yarn specifications, warp and weft density, color value, and fabric weight; and target attribute information of the sample fabric after washing includes at least one of the following: warp and weft tear strength, tear resistance, wear resistance, air permeability, K/S value, compressive stiffness, crease recovery angle, fabric composition, warp and weft yarn specifications, warp and weft density, and color value.

In this embodiment, after the trained parameter prediction model is acquired, the parameter prediction model is used to acquire at least one washing effect corresponding to a to-be-selected fabric. An optional implementation is as follows: first, original attribute information of a to-be-selected fabric is acquired; the original attribute information is inputted into the washing prediction model to predict at least one type of target attribute information after the to-be-selected fabric is washed using at least one washing method; and according to the at least one type of target attribute information, at least one washing effect is generated and outputted. In this embodiment, the at least one washing effect is displayed on the electronic display screen of the terminal device. The format for the at least one washing effect outputted from the server may further include, but is not limited to, the following manners: returning the at least one washing effect to a data requester using manners such as emails, application messages, and short messages; the at least one washing effect is delivered using voice, and the at least one washing effect is delivered via printing with a printer.

In the above-described embodiment, the manner in which the original attribute information of the to-be-selected fabric is acquired includes, but is not limited to, the following.

Acquisition manner I: receive a fabric attribute acquisition request sent by the terminal device, wherein the fabric attribute acquisition request carries an identification of a to-be-washed fabric; according to the identification of the to-be-washed fabric, original attribute information of the to-be-washed fabric is acquired from a database as the original attribute information of the to-be-selected fabric.

Acquisition manner II: receive the original attribute information of the to-be-selected fabric tested and reported by a testing device before the to-be-selected fabric is washed.

Acquisition manner III: receive a fabric attribute acquisition request sent by the terminal device, wherein the fabric attribute acquisition request carries an identification of a to-be-washed fabric; according to the identification of the to-be-washed fabric, acquire from a database some original attribute information of the to-be-washed fabric; and the server receives the remaining original attribute information of the to-be-washed fabric tested and reported by a testing device before the to-be-washed fabric is washed as the original attribute information of the to-be-selected fabric.

In the above-described acquisition manner I, the original attribute information of the to-be-selected fabric is pre-stored; the fabric attribute acquisition request sent by the terminal device is received, and the identification of the to-be-washed fabric is identified from the fabric attribute acquisition request; according to the identification of the to-be-washed fabric, original attribute information of the to-be-washed fabric is acquired from the database as the original attribute information of the to-be-selected fabric.

In the above-described acquisition manner II, the original attribute information of the to-be-selected fabric may further be acquired by testing the physical to-be-selected fabric with various testing devices, for example, by testing the color value of the to-be-selected fabric with a colorimeter, by testing the fabric weight of the to-be-selected fabric with a weight sensor, etc.

In the above-described acquisition manner III, some original attribute information of the to-be-selected fabric is acquired using the above-described acquisition manner I, and the remaining original attribute information of the to-be-selected fabric is acquired using the above-described acquisition manner II.

It should be noted that in this embodiment, the at least one washing effect is a predicted effect after the to-be-washed fabric is washed using at least one washing method. Different washing effects may be acquired when the to-be-selected fabric is washed using different washing methods. Here, a washing method includes at least one washing process performed in sequence, and the parameters of the washing process in different washing methods are not exactly the same. For example, different washing methods for the to-be-selected fabric, namely washing method M1, washing method M2, and washing method M3, can produce different washing effects, namely washing effect E1, washing effect E2, and washing effect E3. The washing method M1 includes a washing process A and a washing process B, wherein the washing process A includes a parameter a1 and a parameter a2, and the washing process B comprises a parameter b1 and a parameter b2. When the to-be-selected fabric is washed using the washing method M1, the washing parameters included therein are the parameter a1 and the parameter b2.

In the embodiments of the data processing method according to the present disclosure, first, original attribute information of a to-be-washed fabric is acquired; the original attribute information is inputted into the washing prediction model, so as to predict at least one type of target attribute information after the to-be-washed fabric is washed using at least one washing method; and finally, according to the at least one type of target attribute information, at least one washing effect is generated and outputted. The target attribute information of the to-be-washed fabric can thus be predicted using the washing prediction model to obtain at least one washing effect, which is expected to be achieved through washing.

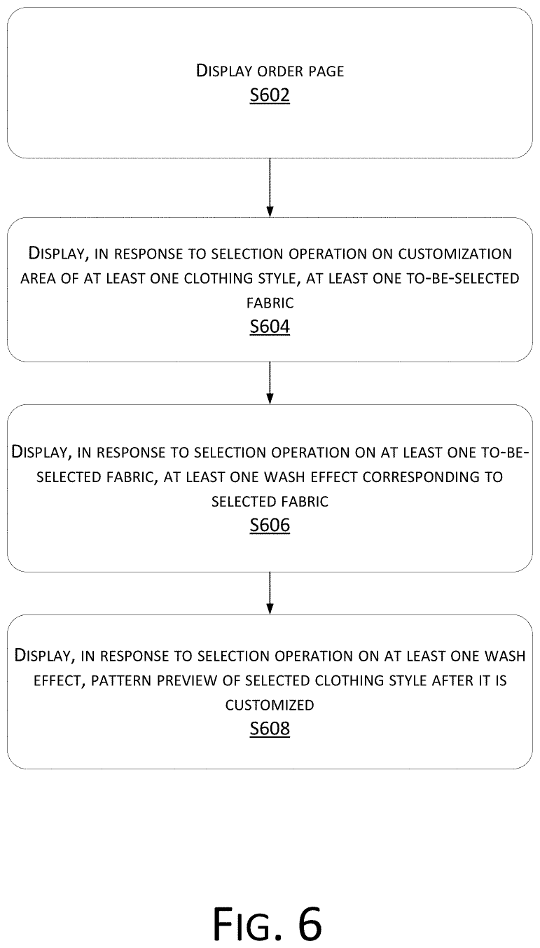

Based on the description of the above-described embodiments, FIG. 6 is a schematic flowchart of an order generation method according to an exemplary embodiment of the present disclosure. As shown in FIG. 6, the method comprises the following steps:

S602: display an order page, wherein the order page comprises at least one clothing style;

S604: display, in response to a selection operation on a customization area of the at least one clothing style, at least one to-be-selected fabric;

S606: display, in response to a selection operation on the at least one to-be-selected fabric, at least one washing effect corresponding to the selected fabric; and

S608: display, in response to a selection operation on the at least one washing effect, a pattern preview of a selected clothing style after it is customized.

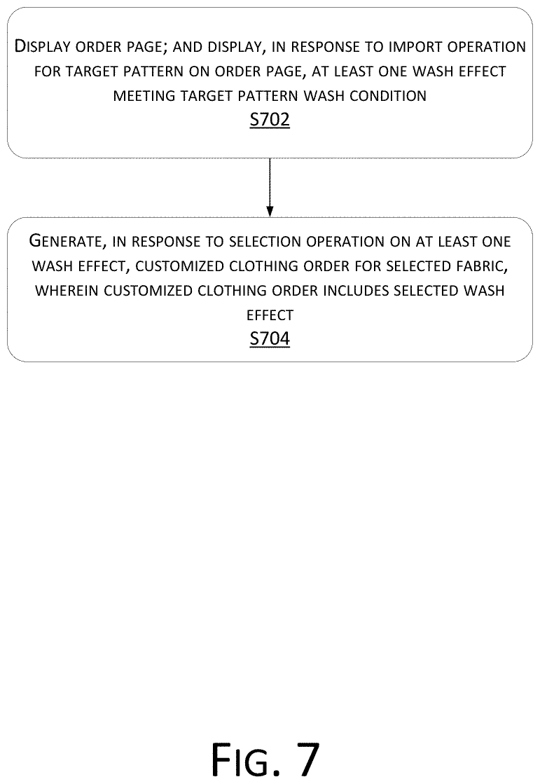

Based on the description of the above-described embodiments, FIG. 7 is a schematic flowchart of an order generation method according to an exemplary embodiment of the present disclosure. As shown in FIG. 7, the method comprises the following steps:

S702: display an order page; and display, in response to an import operation for a target pattern on the order page, at least one washing effect meeting a target pattern washing condition; and

S704: generate, in response to a selection operation on the at least one washing effect, a customized clothing order for the selected fabric, wherein the customized clothing order comprises the selected washing effect.

In this embodiment, after the server acquires the target pattern, a similarity level between the target pattern and the at least one washing effect in the database is calculated. The washing effects having a similarity level meeting a preset condition is displayed on the order page.

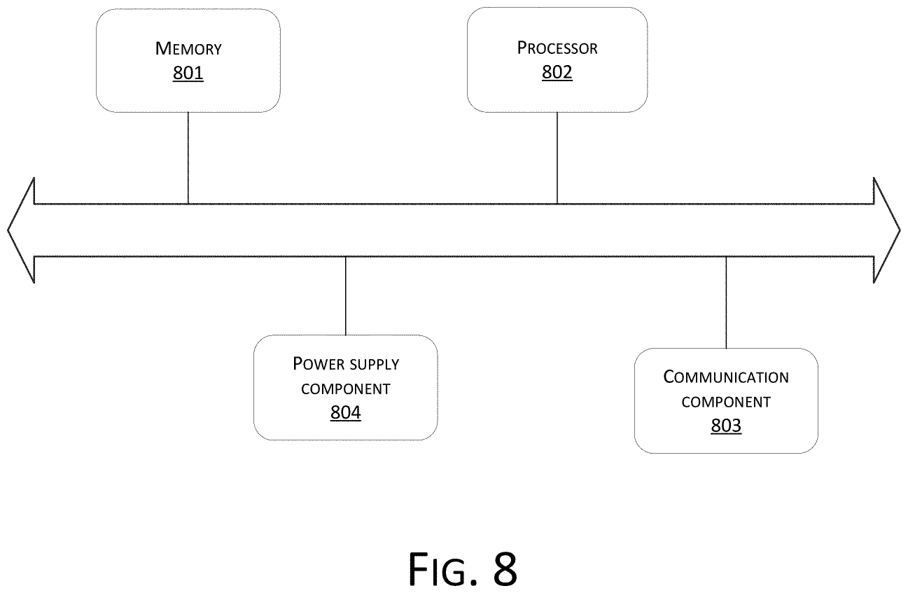

FIG. 8 is a schematic structural diagram of a terminal device according to an exemplary embodiment of the present disclosure. As shown in FIG. 8, the terminal device includes: a memory 802 and a processor 804. In addition, the terminal device further includes necessary components, such as a communication component 806 and a power supply component 808.

The memory 802 is configured to store a computer program and can be configured to store other various data to support operations on a data processing device. Examples of such data include instructions for any application or method to be operated on the data processing device. The memory 802 is an example of computer-readable media.

The memory 802 can be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (P902ROM), a read-only memory (ROM), a magnetic memory, a flash memory, a magnetic disk, or an optical disk.

The communication component 806 is configured to send a data request instruction to a server and receive at least one washing effect returned by the server.

The processor 804 can execute computer-readable instructions stored in the memory 802 for: displaying an order page, wherein the order page includes at least one to-be-selected fabric; displaying, in response to a selection operation on the at least one to-be-selected fabric, at least one washing effect corresponding to the selected fabric; and generating, in response to a selection operation on the at least one washing effect, a customized clothing order for the selected fabric, wherein the customized clothing order includes the selected washing effect.

For example, when displaying at least one washing effect corresponding to the selected fabric in responding to a selection operation on the at least one to-be-selected fabric, the processor 804 is specifically configured to: determine, in response to the selection operation on the at least one to-be-selected fabric, at least one washing process to be used for the selected fabric, and display parameters of the at least one washing process; and obtain, in response to a combination operation on the parameters of the at least one washing process, at least one washing parameter combination, and display washing effects corresponding to each of the at least one washing parameter combination.

For example, when generating a customized clothing order for the selected fabric in responding to a selection operation on the at least one washing effect, the processor 804 is specifically configured to: generate, in response to a selection operation on the washing effects corresponding to each of the at least one washing parameter combination, the customized clothing order for the selected fabric, wherein the customized clothing order includes the selected washing effect and a washing parameter combination corresponding to the selected washing effect.

For example, before the response to the selection operation on the at least one washing effect, the processor 804 may be further configured to: determine, among the at least one washing effect, whether a washing effect that meets requirements of the customized clothing order is present. If a washing effect meeting the requirements of the order is not present, at least one new washing parameter combination is obtained in response to a recombination operation on the parameters of the at least one washing process, and new washing effects corresponding to each of the at least one new washing parameter combination are displayed.

For example, the processor 804 may be further configured to: send to a server the selected washing effect, for the server to determine, in accordance with the selected washing effect, a target washing parameter required for a washing device to perform washing on the selected fabric.

For example, when the order page further includes a clothing pattern, the processor 804 may be further configured to: display, in response to a selection operation on a local area of the clothing style pattern, at least one to-be-selected fabric.

For example, the processor 804 may be further configured to: display, in response to a preview operation on a piece of customized clothing, a new clothing style pattern with the local area having been covered with the selected washing effect.

For example, the order page further includes at least one laser pattern. When generating a customized clothing order for the selected fabric in responding to a selection operation on the at least one washing effect, the processor 804 is specifically configured to: determine, in response to the selection operation on the at least one washing effect, the selected washing effect; and generate, in response to a selection operation on the at least one laser pattern, the customized clothing order for the selected fabric, wherein the customized clothing order includes the selected washing effect and the selected laser pattern.

For example, when displaying at least one washing effect corresponding to the selected fabric in responding to a selection operation on the at least one to-be-selected fabric, the processor 804 is specifically configured to: display, in response to the selection operation on the at least one to-be-selected fabric, at least one type of color information that can be used for the selected fabric; and display, in response to a selection operation on the at least one type of color information, at least one washing effect corresponding to the selected fabric according to the selected color information.

For example, when displaying at least one washing effect corresponding to the selected fabric in responding to a selection operation on the at least one to-be-selected fabric, the processor 804, is specifically configured to: send, in response to the selection operation on the at least one to-be-selected fabric, to a server a first request carrying an identification of the selected fabric, for the server to predict at least one washing effect after the selected fabric is washed using at least one washing method and return the same; and receive the at least one washing effect returned by the server and display the same.

For example, the processor 804 may be further configured to: display, in response to the selection operation on the at least one washing effect, at least one washing process and a price thereof included in a target washing method that produces the selected washing effect.

For example, when displaying at least one washing process and a price thereof included in a target washing method that produces the selected washing effect in responding to the selection operation on the at least one washing effect, the processor 804 is specifically configured to: send, in response to the selection operation on the at least one washing effect, to a server a third request carrying an identification of the target washing method, for the server to acquire and return the at least one washing process and the price thereof included in the target washing method; and receive the at least one washing process and the price thereof included in the target washing method returned by the server and display the same.

For example, the processor 804 may be further configured to: acquire and display, in response to the selection operation on the at least one laser pattern, a customization price corresponding to the selected fabric according to the selected washing effect and the selected laser pattern.

For example, when acquiring and displaying the customization price corresponding to the selected fabric according to the selected washing effect and the selected laser pattern, the processor 804 is specifically configured to: send to a server a fourth request carrying an identification of the selected laser pattern, for the server to calculate and return the customization price corresponding to the selected fabric according to the selected washing effect and the selected laser pattern; and receive the customization price for the selected fabric returned by the server and display the same.

For example, the processor 804 may be further configured to achieve the following:

configure the order page to further include an order confirmation control, such that the users may determine whether to place an order; and

in response to a confirmation operation on the order confirmation control, generate the customized clothing order.

For example, before displaying at least one washing effect corresponding to the selected fabric, the processor 804 may be further configured to: predict, by using a washing prediction model, at least one washing effect after the selected fabric is washed using at least one washing method.

Accordingly, embodiments of the present disclosure further provide a computer-readable storage medium having a computer program stored thereon. When the computer-readable storage medium has a computer program stored thereon, the computer program, when executed by one or more processors, causes the one or more computer processors to execute the steps in the method embodiment shown in FIG. 4.

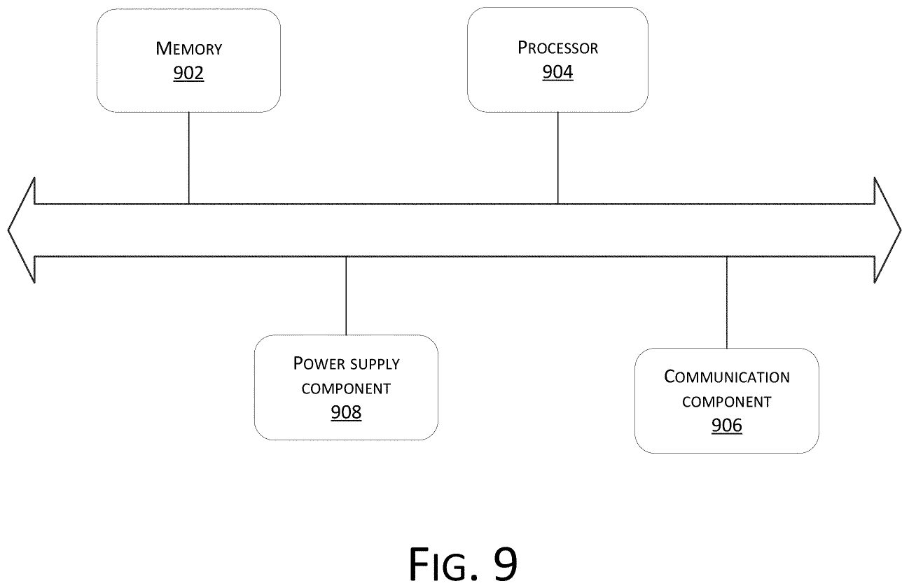

FIG. 9 is a schematic structural diagram of a server according to an exemplary embodiment of the present disclosure. As shown in FIG. 9, the data processing device comprises: a memory 902 and a processor 904. In addition, the data processing device further includes necessary components, such as a communication component 906 and a power supply component 908.

The memory 902 is configured to store a computer program and can be configured to store other various data to support operations on a data processing device. Examples of such data include instructions for any application or method to be operated on the data processing device. The memory 902 is an example of computer-readable media.

The memory 902 can be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The communication component 906 is configured to establish a communication relationship with the terminal device.

The processor 904 can execute computer-readable instructions stored in the memory 902 for: acquiring original attribute information of a to-be-washed fabric; inputting the original attribute information into a washing prediction model, so as to predict at least one type of target attribute information after the to-be-washed fabric is washed using at least one washing method; and generating and outputting at least one washing effect in accordance with the at least one type of target attribute information.

For example, when inputting the original attribute information into the washing prediction model, so as to predict at least one type of target attribute information after the to-be-washed fabric is washed using at least one washing method, the processor 904 is specifically configured to: acquire washing parameters of the at least one washing method; and input the original attribute information and the washing parameters of the at least one washing method into the washing prediction model, so as to predict the at least one type of target attribute information after the to-be-washed fabric is washed using the at least one washing method.

For example, when acquiring the original attribute information of the to-be-washed fabric, the processor 904 is specifically configured to: receive a fabric attribute acquisition request sent by the terminal device, wherein the fabric attribute acquisition request carries an identification of the selected fabric; according to the identification of the selected fabric, acquire from a database original attribute information of the selected fabric as the original attribute information of the to-be-washed fabric; or, receive the original attribute information of the to-be-washed fabric tested and reported by a testing device before the to-be-washed fabric is washed.

For example, the processor 904 inputting the original attribute information and the washing parameters for the at least one washing method into the washing prediction model, so as to predict the at least one type of target attribute information when the to-be-washed fabric is washed using the at least one washing method comprises:

respectively inputting, for each washing method, the original attribute information and washing parameters for each of the washing methods into a deep neural network algorithm, so as to obtain the at least one type of target attribute information after the to-be-washed fabric is washed using the at least one washing method, wherein the deep neural network algorithm reflects a mapping relationship among the original attribute information of the to-be-washed fabric, a washing method used for the to-be-washed fabric, and the at least one type of target attribute information of the to-be-washed fabric after the to-be-washed fabric is washed.

For example, the original attribute information comprises at least one of the following: warp and weft tear strength, tear resistance, wear resistance, air permeability, K/S value, compressive stiffness, crease recovery angle, fabric composition, warp and weft yarn specifications, warp and weft density, color value, and fabric weight. The target attribute information includes at least one of the following: warp and weft tear strength, tear resistance, wear resistance, air permeability, K/S value, compressive stiffness, crease recovery angle, fabric composition, warp and weft yarn specifications, warp and weft density, and color value.

For example, the processor 904 may be further configured to: receive from a washing device the actual attribute information of the to-be-washed fabric after washing and the actual washing parameters used for the to-be-washed fabric; and update the washing prediction model in accordance with attribute information of the to-be-washed fabric before washing, the actual attribute information of the to-be-washed fabric after washing, and the actual washing parameters used for the to-be-washed fabric.

For example, before using the washing prediction model, the processor 904 may be further configured to: input attribute information of a sample fabric before washing, washing parameters used for the sample fabric, and attribute information of the sample fabric after washing into a deep neural network algorithm, so as to establish a mapping relationship among the attribute information of the sample fabric before washing, the washing parameters used for the sample fabric, and the attribute information of the sample fabric after washing, and obtain the washing prediction model.

For example, the processor 904 may be further configured to: receive from a terminal device a first request carrying an identification of the selected fabric, select from a database at least one washing effect corresponding to the selected fabric according to the identification of the selected fabric, and return the at least one washing effect to the terminal device, for the terminal device to display the at least one washing effect; or, receive a second request carrying an identification of the selected fabric sent from a terminal device, select from a database original attribute information of the selected fabric, input the original attribute information into the washing prediction model, so as to predict at least one washing effect after the selected fabric is washed using at least one washing method, and return the at least one washing effect to the terminal device, for the terminal device to display the at least one washing effect.

For example, it may be further configured to: receive from a terminal device a third request carrying an identification of a target washing method; according to the identification of the target washing method, acquire from a database at least one washing process and a price thereof included in the target washing method; and send to the terminal device the at least one washing process and the price thereof included in the target washing method, for the terminal device to display the same.

For example, it may be further configured to: receive a fourth request carrying an identification of a selected laser pattern sent by a terminal device; acquire a customization price corresponding to the selected fabric according to the selected washing effect and the identification of the selected laser pattern; and send to the terminal device the customization price for the selected fabric, for the terminal device to display the customization price for the selected fabric.

Accordingly, embodiments of the present disclosure further provide a computer-readable storage medium having a computer program stored thereon. When the computer-readable storage medium has a computer program stored thereon, the computer program, when executed by one or more processors, causes the one or more computer processors to execute the steps in the method embodiment shown in FIG. 5.

With regard to the terminal device and the server in the embodiments of the present disclosure, first, a terminal device displays an order page; and then, after a selection operation is performed on at least one to-be-selected fabric, at least one washing effect corresponding to the selected fabric is acquired and displayed using a washing prediction model; and finally, a selection operation is performed on the at least one washing effect, and a customized clothing order for the selected fabric is generated. In this way, users may select fabrics via the terminal device, and a washing effect corresponding to a selected fabric may be directly displayed for the users' selection, thus achieving on-line clothing customization and enhancing user experience.

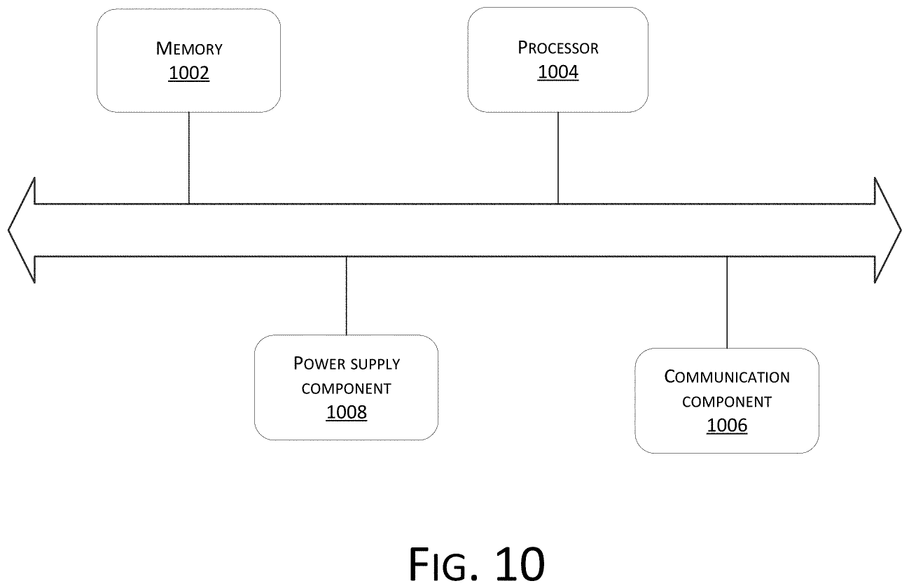

FIG. 10 is a schematic structural diagram of an order generation device according to an exemplary embodiment of the present disclosure. As shown in FIG. 10, the data processing device comprises: a memory 1002 and a processor 1004. In addition, the data processing device further includes necessary components, such as a communication component 1006 and a power supply component 1008.

The memory 1002 is configured to store a computer program and can be configured to store other various data to support operations on a data processing device. Examples of such data include instructions for any application or method to be operated on the data processing device. The memory 1002 is an example of computer-readable media.

The memory 1002 can be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The communication component 1006 is configured to establish a communication relationship with the terminal device.

The processor 1004 may execute computer-readable instructions stored in the memory 1002 for: displaying an order page, wherein the order page includes at least one clothing style; displaying, in response to a selection operation on a customization area of the at least one clothing style, at least one to-be-selected fabric; displaying, in response to a selection operation on the at least one to-be-selected fabric, at least one washing effect corresponding to the selected fabric; and displaying, in response to a selection operation on the at least one washing effect, a pattern preview of a selected clothing style after it is customized.

For example, when displaying at least one washing effect corresponding to the selected fabric in responding to a selection operation on at least one to-be-selected fabric, the processor 1004 is specifically configured to: determine, in response to the selection operation on the at least one to-be-selected fabric, at least one washing process to be used for the selected fabric, and display parameters of the at least one washing process; and obtain, in response to a combination operation on the parameters of the at least one washing process, at least one washing parameter combination, and display washing effects corresponding to each of the at least one washing parameter combination.

Accordingly, embodiments of the present disclosure further provide a computer-readable storage medium having a computer program stored thereon. When the computer-readable storage medium has a computer program stored thereon, the computer program, when executed by one or more processors, causes the one or more computer processors to execute the steps in the method embodiment shown in FIG. 6.

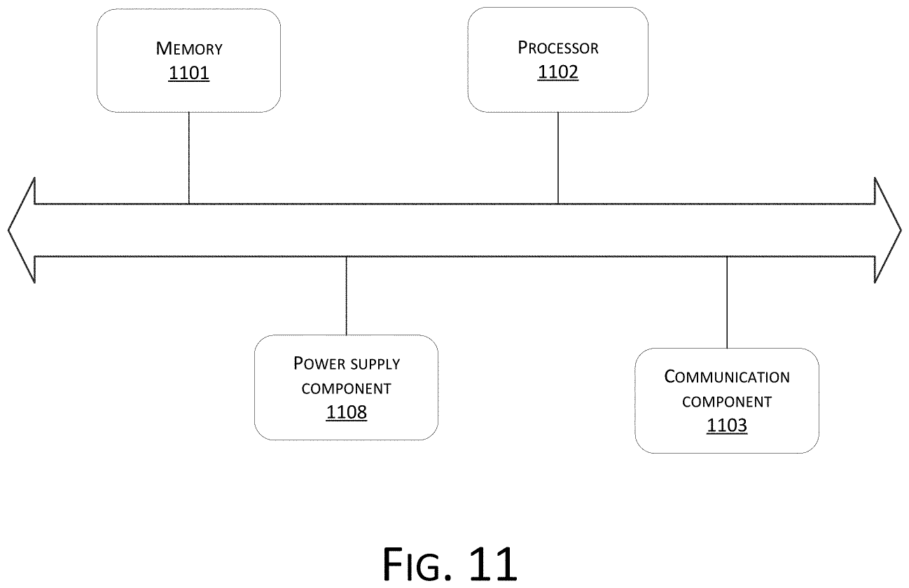

FIG. 11 is a schematic structural diagram of an order generation device according to an exemplary embodiment of the present disclosure. As shown in FIG. 11, the data processing device comprises: a memory 1102 and a processor 1104. In addition, the data processing device further includes necessary components, such as a communication component 1106 and a power supply component 1108.

The memory 1102 is configured to store a computer program and can be configured to store other various data to support operations on a data processing device. Examples of such data include instructions for any application or method to be operated on the data processing device. The memory 1102 is an example of computer-readable media.

The memory 1102 can be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The communication component 1106 is configured to establish a communication relationship with the terminal device.

The processor 1104 can execute computer-readable instructions stored in the memory 1102 for: displaying an order page; displaying, in response to an import operation for a target pattern on the order page, at least one washing effect meeting a target pattern washing condition; and generating, in response to a selection operation on the at least one washing effect, a customized clothing order for the selected fabric, wherein the customized clothing order includes the selected washing effect.

Accordingly, embodiments of the present disclosure further provide a computer-readable storage medium having a computer program stored thereon. When the computer-readable storage medium has a computer program stored thereon, the computer program, when executed by one or more processors, causes the one or more computer processors to execute the steps in the method embodiment shown in FIG. 7.

The communication components in FIGS. 8-11 above are configured to facilitate wired or wireless communications between the devices in which the communication components are located and other devices. The devices in which the communication components are located may access a wireless network based on communication standards such as Wi-Fi, 2G, 3G, or a combination thereof. In one exemplary embodiment, the communication components receive, from an external broadcast management system, a broadcast signal or broadcast-related information via a broadcast channel. In one exemplary embodiment, the communication components further include near-field communication (NFC) technologies, radio-frequency identification (RFID) technologies, infrared data association (IrDA) technologies, ultra-wideband (UWB) technologies, Bluetooth (BT) technologies, and the like to facilitate short range communications.

The power supply components in FIGS. 8-11 above provide power for various components of the devices in which the power supply components are located. The power supply components may include a power management system, one or more power supplies, and other components associated with generating, managing, and distributing power for the devices in which the power supply components are located.

Those skilled in the art should understand that the embodiments of the present invention may be provided as a method, a system, or a computer program product. Therefore, the present invention may take a form of an entirely hardware embodiment, an entirely software embodiment, or an embodiment combining software and hardware elements. Furthermore, the present invention may take a form of a computer program product implemented on one or more computer-usable storage media (including, but not limited to, disk memories, CD-ROMs, optical memories, etc.) having computer-usable program codes included therein.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by a computer or a processor of another programmable data processing device generate an apparatus for implementing a specific function in one or more processes in the flowcharts and/or in one or more blocks in the block diagrams.

These computer program instructions may be stored in a computer readable memory that can instruct the computer or another programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operation steps are performed on the computer or another programmable device to generate computer-implemented processing. Therefore, the instructions executed on the computer or another programmable device are used to provide steps for implementing a specific function in one or more processes in the flowcharts and/or in one or more blocks in the block diagrams.

In a typical configuration, a computing device includes one or more processors (CPU), an input/output interface, a network interface, and a memory.

The memory may include a volatile memory on a computer-readable medium, a random access memory (RAM) and/or a non-volatile memory, and the like, such as a read-only memory (ROM) or a flash random access memory (flash RAM). The memory is an example of the computer-readable media.

Computer-readable media further include nonvolatile and volatile, removable and non-removable media employing any method or technique to achieve information storage. The information may be computer readable instructions, data structures, modules of programs, or other data. Examples of computer storage media include, but are not limited to, a phase-change random access memory (PRAM), a static random access memory (SRAM), a dynamic random access memory (DRAM), other types of random access memories (RAM), a read-only memory (ROM), an electrically erasable programmable read-only memory (EEPROM), a flash memory or other memory technologies, a compact disc read-only memory (CD-ROM), a digital versatile disc (DVD) or other optical memories, a magnetic cassette tape, a magnetic tape, a magnetic disk storage or other magnetic storage devices or any other non-transmission medium, which may be used to store information that can be accessed by a computing device. As defined herein, the computer-readable media do not include transitory media, such as modulated data signals and carriers.

It should be further noted that the terms “include,” “comprise,” or any other variants thereof are intended to encompass non-exclusive inclusion, so that a process, method, product, or device that involves a series of elements comprises not only those elements, but also other elements not explicitly listed, or elements that are inherent to such a process, method, product, or device. Unless more limitations are stated, an element defined by the phrase “including a . . . ” does not exclude the existence of another identical element in the process, method, product, or device that includes the element.

The description above are merely embodiments of the present disclosure and are not intended to limit the present disclosure. For those skilled in the art, the present disclosure may have various modifications and changes. Any modification, equivalent replacement, improvement, and the like made within the spirit and principle of the present disclosure shall fall within the protection scope of the claims of the present disclosure.

The present disclosure may further be understood with clauses as follows:

Clause 1. An order generation method, the method comprising:

displaying an order page, wherein the order page comprises at least one to-be-selected fabric;

displaying, in response to a selection operation on the at least one to-be-selected fabric, at least one washing effect corresponding to the selected fabric; and

generating, in response to a selection operation on the at least one washing effect, a customized clothing order for the selected fabric, wherein the customized clothing order comprises the selected washing effect.

Clause 2. The method according to clause 1, wherein the displaying, in response to the selection operation on the at least one to-be-selected fabric, at least one washing effect corresponding to the selected fabric comprises:

determining, in response to the selection operation on the at least one to-be-selected fabric, at least one washing process required to be used for the selected fabric, and displaying parameters of the at least one washing process; and

obtaining, in response to a combination operation on the parameters of the at least one washing process, at least one washing parameter combination, and displaying washing effects corresponding to each of the at least one washing parameter combination.

Clause 3. The method according to clause 2, wherein the generating, in response to the selection operation on the at least one washing effect, the customized clothing order for the selected fabric comprises:

generating, in response to a selection operation on the washing effects corresponding to each of the at least one washing parameter combination, the customized clothing order for the selected fabric, wherein the customized clothing order comprises the selected washing effect and a washing parameter combination corresponding to the selected washing effect.

Clause 4. The method according to clause 2, wherein before the responding to the selection operation on the at least one washing effect, the method further comprises:

determining, among the at least one washing effect, whether a washing effect meeting requirements of the order is present; and

if a washing effect meeting the requirements of the order is not present, obtaining, in response to a recombination operation on the parameters of the at least one washing process, at least one new washing parameter combination, and displaying new washing effects corresponding to each of the at least one new washing parameter combination.

Clause 5. The method according to clause 1, further comprising:

sending to a server the selected washing effect, for the server to determine, in accordance with the selected washing effect, a target washing parameter required for a washing device to perform washing on the selected fabric.

Clause 6. The method according to clause 1, wherein the order page further comprises a clothing style pattern, the method further comprising:

displaying, in response to a selection operation on a local area of the clothing style pattern, at least one to-be-selected fabric.

Clause 7. The method according to clause 6, further comprising:

displaying, in response to a preview operation on a piece of customized clothing, a new clothing style pattern with the local area having been covered with the selected washing effect.

Clause 8. The method according to clause 1, wherein at least one laser pattern is further displayed on the order page; and

the generating, in response to the selection operation on the at least one washing effect, the customized clothing order for the selected fabric comprises:

determining, in response to the selection operation on the at least one washing effect, the selected washing effect; and

generating, in response to a selection operation on the at least one laser pattern, the customized clothing order for the selected fabric, wherein the customized clothing order comprises the selected washing effect and the selected laser pattern.

Clause 9. The method according to clause 1, wherein the displaying, in response to the selection operation on the at least one to-be-selected fabric, at least one washing effect corresponding to the selected fabric comprises:

displaying, in response to the selection operation on the at least one to-be-selected fabric, at least one type of color information that can be used for the selected fabric; and

displaying, in response to a selection operation on the at least one type of color information, at least one washing effect corresponding to the selected fabric in accordance with the selected color information.

Clause 10. The method according to clause 1, wherein the displaying, in response to the selection operation on the at least one to-be-selected fabric, at least one washing effect corresponding to the selected fabric comprises:

sending, in response to the selection operation on the at least one to-be-selected fabric, to a server a first request carrying an identification of the selected fabric, for the server to predict at least one washing effect after the selected fabric is washed using at least one washing method and to return the same; and

receiving the at least one washing effect returned by the server and displaying the same.

Clause 11. The method according to clause 1, further comprising:

displaying, in response to the selection operation on the at least one washing effect, at least one washing process and a price thereof comprised in a target washing method producing the selected washing effect.

Clause 12. The method according to clause 10, wherein the displaying, in response to the selection operation on the at least one washing effect, at least one washing process and the price thereof comprised in the target washing method producing the selected washing effect comprises:

sending, in response to the selection operation on the at least one washing effect, to the server a third request carrying an identification of the target washing method, for the server to acquire and return the at least one washing process and the price thereof comprised in the target washing method; and

receiving the at least one washing process and the price thereof comprised in the target washing method returned by the server and displaying the same.

Clause 13. The method according to clause 6, further comprising:

acquiring and displaying, in response to the selection operation on the at least one laser pattern, a customization price corresponding to the selected fabric according to the selected washing effect and the selected laser pattern.

Clause 14. The method according to clause 13, wherein the acquiring and displaying the customization price corresponding to the selected fabric according to the selected washing effect and the selected laser pattern comprises:

sending to a server a fourth request carrying an identification of the selected laser pattern, for the server to calculate and return the customization price corresponding to the selected fabric according to the selected washing effect and the selected laser pattern; and

receiving the customization price corresponding to the selected fabric returned by the server and displaying the same.

Clause 15. The method according to clause 1, further comprising

configuring the order page to further comprise an order confirmation control, such that the users may determine whether to place an order; and

generating, in response to a confirmation operation on the order confirmation control, the customized clothing order.

Clause 16. The method according to clause 1, before the displaying the at least one washing effect corresponding to the selected fabric, the method further comprises:

predicting, by using a washing prediction model, at least one washing effect after the selected fabric is washed using at least one washing method.

Clause 17. A data processing method, the method comprising:

acquiring original attribute information of a to-be-washed fabric;

inputting the original attribute information into a washing prediction model, so as to predict at least one type of target attribute information after the to-be-washed fabric is washed using at least one washing method; and

generating and outputting at least one washing effect according to the at least one type of target attribute information.

Clause 18. The method according to clause 17, wherein the inputting the original attribute information into the washing prediction model, so as to predict at least one type of target attribute information after the to-be-washed fabric is washed using the at least one washing method comprises:

acquiring washing parameters for the at least one washing method; and

inputting the original attribute information and the washing parameters for the at least one washing method into the washing prediction model, so as to predict the at least one type of target attribute information after the to-be-washed fabric is washed using the at least one washing method.

Clause 19. The method according to clause 17, wherein the acquiring original attribute information of the to-be-washed fabric comprises:

receiving a fabric attribute acquisition request sent by a terminal device, wherein the fabric attribute acquisition request carries an identification of a selected fabric; and acquiring, according to the identification of the selected fabric, from a database, original attribute information of the selected fabric as the original attribute information of the to-be-washed fabric; or,

receiving the original attribute information of the to-be-washed fabric tested and reported by a testing device before performing washing on the to-be-washed fabric.

Clause 20. The method according to clause 18, wherein the inputting the original attribute information and the washing parameters for the at least one washing method into the washing prediction model, so as to predict the at least one type of target attribute information after the to-be-washed fabric is washed using the at least one washing method comprises:

respectively inputting, for each washing method, the original attribute information and washing parameters for each of the washing methods into a deep neural network algorithm, so as to obtain the at least one type of target attribute information after the to-be-washed fabric is washed using the at least one washing method, wherein the deep neural network algorithm reflects a mapping relationship among the original attribute information of the to-be-washed fabric, a washing method used for the to-be-washed fabric, and the at least one type of target attribute information of the to-be-washed fabric after the to-be-washed fabric is washed.

Clause 21. The method according to any one of clauses 17-20, wherein

the original attribute information comprises at least one of the following: warp and weft tear strength, tear resistance, wear resistance, air permeability, K/S value, compressive stiffness, crease recovery angle, fabric composition, warp and weft yarn specifications, warp and weft density, color value, and fabric weight; and

the target attribute information comprises at least one of the following: warp and weft tear strength, tear resistance, wear resistance, air permeability, K/S value, compressive stiffness, crease recovery angle, fabric composition, warp and weft yarn specifications, warp and weft density, and color value.

Clause 22. The method according to clause 17, further comprising:

receiving, from a washing device, actual attribute information of the to-be-washed fabric after washing and actual washing parameters used for the to-be-washed fabric; and

updating the washing prediction model in accordance with attribute information of the to-be-washed fabric before washing, the actual attribute information of the to-be-washed fabric after washing, and the actual washing parameters used for the to-be-washed fabric.

Clause 23. The method according to clause 17, wherein before using the washing prediction model, the method further comprises:

inputting attribute information of a sample fabric before washing, washing parameters used for the sample fabric, and attribute information of the sample fabric after washing into a deep neural network algorithm, so as to establish a mapping relationship among the attribute information of the sample fabric before washing, the washing parameters used for the sample fabric, and the attribute information of the sample fabric after washing, and obtaining the washing prediction model.

Clause 24. The method according to clause 17, further comprising:

receiving a first request carrying an identification of the selected fabric sent by a terminal device, selecting from a database at least one washing effect corresponding to the selected fabric, and returning the at least one washing effect to the terminal device, for the terminal device to display the at least one washing effect; or

receiving a second request carrying an identification of the selected fabric sent from a terminal device, selecting, from a database, original attribute information of the selected fabric, inputting the original attribute information into the washing prediction model, so as to predict at least one washing effect after the selected fabric is washed using at least one washing method, and returning the at least one washing effect to the terminal device, for the terminal device to display the at least one washing effect.

Clause 25. The method according to clause 17, further comprising:

receiving a third request carrying an identification of a target washing method sent by a terminal device;

acquiring, according to the identification of the target washing method, from a database at least one washing process and a price thereof comprised in the target washing method; and

sending to the terminal device the at least one washing process and the price thereof comprised in the target washing method, for the terminal device to display the same.

Clause 26. The method according to clause 17, further comprising:

receiving a fourth request carrying an identification of a selected laser pattern sent by a terminal device;

acquiring, according to the identification of the selected laser pattern, from a database a customization price corresponding to the selected fabric; and

sending to the terminal device the customization price corresponding to the selected fabric, for the terminal device to display the customization price corresponding to the selected fabric.

Clause 27. A clothing customization system, comprising: a terminal device and a server, wherein

the terminal device displays, in response to a selection operation on at least one to-be-selected fabric, at least one washing effect corresponding to the selected fabric sent by the server, and generates, in response to a selection operation on the at least one washing effect, a customized clothing order for the selected fabric, wherein the customized clothing order comprises the selected washing effect; and

the server predicts, according to original attribute information of the selected fabric, at least one type of target attribute information after the selected fabric is washed using at least one washing method, so as to generate the at least one washing effect corresponding to the selected fabric.

Clause 28. A washing system, comprising: a terminal device, a server, and a washing device, wherein

the terminal device displays, in response to a selection operation on at least one to-be-selected fabric, at least one washing effect corresponding to the selected fabric sent by the server, and generates, in response to a selection operation on the at least one washing effect, a customized clothing order for the selected fabric, wherein the customized clothing order comprises the selected washing effect; and

the server predicts, according to original attribute information of the selected fabric, at least one type of target attribute information after the selected fabric is washed using at least one washing method, so as to generate the at least one washing effect corresponding to the selected fabric, and sends washing parameters corresponding to the selected washing effect to the washing device; and

the washing device washes the selected fabric according to the washing parameters corresponding to the selected washing effect issued by the server.

Clause 29. A terminal device, comprising: a memory and a processor, wherein

the memory is configured to store one or more computer-readable instructions; and

the processor is configured to execute the one or more computer-readable instructions for:

displaying an order page, wherein the order page comprises at least one to-be-selected fabric;

displaying, in response to a selection operation on the at least one to-be-selected fabric, at least one washing effect corresponding to the selected fabric; and

generating, in response to a selection operation on the at least one washing effect, a customized clothing order for the selected fabric, wherein the customized clothing order comprises the selected washing effect.

Clause 30. A computer-readable storage medium having a computer program stored thereon, wherein the computer program, when executed by one or more processors, causes the one or more processors to execute the following actions:

displaying an order page, wherein the order page comprises at least one to-be-selected fabric;

displaying, in response to a selection operation on the at least one to-be-selected fabric, at least one washing effect corresponding to the selected fabric; and

generating, in response to a selection operation on the at least one washing effect, a customized clothing order for the selected fabric, wherein the customized clothing order comprises the selected washing effect.

Clause 31. A server, comprising: a memory and a processor, wherein

the memory is configured to store one or more computer-readable instructions; and

the processor is configured to execute the one or more computer-readable instructions for:

acquiring original attribute information of a to-be-washed fabric;

inputting the original attribute information into a washing prediction model, so as to predict at least one type of target attribute information after the to-be-washed fabric is washed using at least one washing method; and

generating and outputting at least one washing effect according to the at least one type of target attribute information.

Clause 32. A computer-readable storage medium having a computer program stored thereon, wherein the computer program, when executed by one or more processors, causes the one or more processors to execute the following actions:

acquiring original attribute information of a to-be-washed fabric;

inputting the original attribute information into a washing prediction model, so as to predict at least one type of target attribute information after the to-be-washed fabric is washed using at least one washing method; and

generating and outputting at least one washing effect according to the at least one type of target attribute information.

Clause 33. An order generation method, comprising:

displaying an order page, wherein the order page comprises at least one clothing style;

displaying, in response to a selection operation on a customization area of the at least one clothing style, at least one to-be-selected fabric;

displaying, in response to a selection operation on the at least one to-be-selected fabric, at least one washing effect corresponding to the selected fabric; and

displaying, in response to a selection operation on the at least one washing effect, a pattern preview of a selected clothing style after it is customized.

Clause 34. The method according to clause 33, wherein the displaying, in response to the selection operation on the at least one to-be-selected fabric, at least one washing effect corresponding to the selected fabric comprises:

determining, in response to the selection operation on the at least one to-be-selected fabric, at least one washing process required to be used for the selected fabric, and displaying parameters of the at least one washing process; and

obtaining, in response to a combination operation on the parameters of the at least one washing process, at least one washing parameter combination, and displaying washing effects corresponding to each of the at least one washing parameter combination.

Clause 35. An order generation method, comprising:

displaying an order page; and displaying, in response to an import operation for a target pattern on the order page, at least one washing effect meeting a target pattern washing condition; and

generating, in response to a selection operation on the at least one washing effect, a customized clothing order for the selected fabric, wherein the customized clothing order comprises the selected washing effect.

Clause 36. An order generation device, comprising: a memory and a processor, wherein

the memory is configured to store one or more computer-readable instructions; and

the processor is configured to execute the one or more computer-readable instructions for:

displaying an order page, wherein the order page comprises at least one clothing style;

displaying, in response to a selection operation on a customization area of the at least one clothing style, at least one to-be-selected fabric;

displaying, in response to a selection operation on the at least one to-be-selected fabric, at least one washing effect corresponding to the selected fabric; and

displaying, in response to a selection operation on the at least one washing effect, a pattern preview of a selected clothing style after it is customized.

Clause 37. A computer-readable storage medium having a computer program stored thereon, wherein the computer program, when executed by one or more processors, causes the one or more processors to execute the following actions:

displaying an order page, wherein the order page comprises at least one clothing style;

displaying, in response to a selection operation on a customization area of the at least one clothing style, at least one to-be-selected fabric;

displaying, in response to a selection operation on the at least one to-be-selected fabric, at least one washing effect corresponding to the selected fabric; and

displaying, in response to a selection operation on the at least one washing effect, a pattern preview of a selected clothing style after it is customized.

Clause 38. An order generation device, comprising: a memory and a processor, wherein

the memory is configured to store one or more computer-readable instructions; and

the processor is configured to execute the one or more computer-readable instructions for:

displaying an order page; and displaying, in response to an import operation for a target pattern on the order page, at least one washing effect meeting a target pattern washing condition; and

generating, in response to a selection operation on the at least one washing effect, a customized clothing order for the selected fabric, wherein the customized clothing order comprises the selected washing effect.

Clause 39. A computer-readable storage medium having a computer program stored thereon, wherein the computer program, when executed by one or more processors, causes the one or more processors to execute the following actions:

displaying an order page; and displaying, in response to an import operation for a target pattern on the order page, at least one washing effect meeting a target pattern washing condition; and

generating, in response to a selection operation on the at least one washing effect, a customized clothing order for the selected fabric, wherein the customized clothing order comprises the selected washing effect.

What is claimed is:

1. A method comprising:
displaying an order page, the order page including at least one to-be-selected fabric;
displaying, in response to a selection operation on the at least one to-be-selected fabric, at least one washing effect corresponding to the selected fabric; and
generating, in response to a selection operation on the at least one washing effect, a customized clothing order for the selected fabric, the customized clothing order including the selected washing effect.

2. The method according to claim 1, wherein the displaying, in response to the selection operation on the at least one to-be-selected fabric, at least one washing effect corresponding to the selected fabric comprises:
determining, in response to the selection operation on the at least one to-be-selected fabric, at least one washing process required to be used for the selected fabric;
displaying parameters of the at least one washing process; and
obtaining, in response to a combination operation on the parameters of the at least one washing process, at least one washing parameter combination, and displaying washing effects corresponding to each of the at least one washing parameter combination.

3. The method according to claim 2, wherein the generating, in response to the selection operation on the at least one washing effect, the customized clothing order for the selected fabric comprises:
generating, in response to a selection operation on the washing effects corresponding to each of the at least one washing parameter combination, the customized clothing order for the selected fabric, the customized clothing order including the selected washing effect and a washing parameter combination corresponding to the selected washing effect.

4. The method according to claim 2, wherein before the responding to the selection operation on the at least one washing effect, the method further comprises:
determining, among the at least one washing effect, that a washing effect meeting requirements of the order is not present; and
obtaining, in response to a recombination operation on the parameters of the at least one washing process, at least one new washing parameter combination, and displaying new washing effects corresponding to each of the at least one new washing parameter combination.

5. The method according to claim 1, further comprising:
sending to a server the selected washing effect for the server to determine, in accordance with the selected washing effect, a target washing parameter required for a washing device to perform washing on the selected fabric.

6. The method according to claim 1, wherein:
the order page further includes a clothing style pattern; and
the method further comprises displaying, in response to a selection operation on a local area of the clothing style pattern, at least one to-be-selected fabric.

7. The method according to claim 6, further comprising:
displaying, in response to a preview operation on a piece of customized clothing, a new clothing style pattern with the local area having been covered with the selected washing effect.

8. The method according to claim 1, wherein:
at least one laser pattern is further displayed on the order page; and
the generating, in response to the selection operation on the at least one washing effect, the customized clothing order for the selected fabric comprises:
determining, in response to the selection operation on the at least one washing effect, the selected washing effect; and
generating, in response to a selection operation on the at least one laser pattern, the customized clothing order for the selected fabric, wherein the customized clothing order comprises the selected washing effect and the selected laser pattern.

9. The method according to claim 1, wherein the displaying, in response to the selection operation on the at least one to-be-selected fabric, at least one washing effect corresponding to the selected fabric comprises:
displaying, in response to the selection operation on the at least one to-be-selected fabric, at least one type of color information that can be used for the selected fabric; and
displaying, in response to a selection operation on the at least one type of color information, at least one washing effect corresponding to the selected fabric in accordance with the selected color information.

10. The method according to claim 1, wherein the displaying, in response to the selection operation on the at least one to-be-selected fabric, at least one washing effect corresponding to the selected fabric comprises:
sending, in response to the selection operation on the at least one to-be-selected fabric, to a server a first request carrying an identification of the selected fabric, for the server to predict at least one washing effect after the selected fabric is washed using at least one washing method;
receiving the at least one washing effect returned by the server; and
displaying the at least one washing effect.

11. The method according to claim 1, further comprising:
displaying, in response to the selection operation on the at least one washing effect, at least one washing process and a corresponding price comprised in a target washing method producing the selected washing effect.

12. The method according to claim 10, wherein the displaying, in response to the selection operation on the at least one washing effect, at least one washing process and the corresponding price comprised in the target washing method producing the selected washing effect comprises:
sending, in response to the selection operation on the at least one washing effect, to the server a third request carrying an identification of the target washing method, for the server to acquire and return the at least one washing process and the corresponding price comprised in the target washing method;
receiving the at least one washing process and the corresponding price comprised in the target washing method returned by the server; and
displaying the at least one washing process and the corresponding price.

13. The method according to claim 6, further comprising:
acquiring and displaying, in response to the selection operation on the at least one laser pattern, a customization price corresponding to the selected fabric according to the selected washing effect and the selected laser pattern.

14. The method according to claim 13, wherein the acquiring and displaying the customization price corresponding to the selected fabric according to the selected washing effect and the selected laser pattern comprises:
sending to a server a fourth request carrying an identification of the selected laser pattern, for the server to calculate and return the customization price corresponding to the selected fabric according to the selected washing effect and the selected laser pattern;
receiving the customization price corresponding to the selected fabric returned by the server; and
displaying the customization price.

15. The method according to claim 1, further comprising configuring the order page to further comprise an order confirmation control for a user to place an order; and
generating, in response to a confirmation operation on the order confirmation control, the customized clothing order.

16. The method according to claim 1, before the displaying the at least one washing effect corresponding to the selected fabric, the method further comprises:
predicting, by using a washing prediction model, at least one washing effect after the selected fabric is washed using at least one washing method.

17. A device comprising:
one or more processors; and
one or more memories storing thereon computer-readable instructions that, when executed by the one or more processors, cause the one or more processors to perform acts comprising:
acquiring original attribute information of a to-be-washed fabric;
inputting the original attribute information into a washing prediction model to predict at least one type of target attribute information after the to-be-washed fabric is washed using at least one washing method; and
generating and outputting at least one washing effect according to the at least one type of target attribute information.

18. The method according to claim 17, wherein the inputting the original attribute information into the washing prediction model, so as to predict at least one type of target attribute information after the to-be-washed fabric is washed using the at least one washing method comprises:
acquiring washing parameters for the at least one washing method; and
inputting the original attribute information and the washing parameters for the at least one washing method into the washing prediction model, so as to predict the at least one type of target attribute information after the to-be-washed fabric is washed using the at least one washing method.

19. The method according to claim 17, wherein the acquiring the original attribute information of the to-be-washed fabric comprises:
receiving a fabric attribute acquisition request sent by a terminal device, wherein the fabric attribute acquisition request carries an identification of a selected fabric; and acquiring, according to the identification of the selected fabric, from a database, original attribute information of the selected fabric as the original attribute information of the to-be-washed fabric; or
receiving the original attribute information of the to-be-washed fabric tested and reported by a testing device before performing washing on the to-be-washed fabric.

20. One or more memories storing thereon computer-readable instructions that, when executed by the one or more processors, cause the one or more processors to perform acts comprising:
inputting attribute information of a sample fabric before washing, washing parameters used for the sample fabric, and attribute information of the sample fabric after washing into a deep neural network algorithm to establish a mapping relationship among the attribute information of the sample fabric before washing, the washing parameters used for the sample fabric, and the attribute information of the sample fabric after washing, and obtaining a washing prediction model;
acquiring original attribute information of a to-be-washed fabric;
inputting the original attribute information into the washing prediction model to predict at least one type of target attribute information after the to-be-washed fabric is washed using at least one washing method; and
generating and outputting at least one washing effect according to the at least one type of target attribute information.
